(19) United States
(12) Patent Application Publication
(10) Pub. No.: US 2007/0243898 A1
(43) Pub. Date: Oct. 18, 2007

(54) Multi-handset cordless voice over IP telephony system

(76) Inventors: Alan Eyre, (US); Corey Fehr, (US); Sean Gross, Calgary (CA); Henry Leong, Calgary (CA); Paulo Francisco, Woodbridge (CA)

Correspondence Address: Ralph A. Dowell of DOWELL & DOWELL P.C., 2111 Eisenhower Ave, Suite 406, Alexandria, VA, 22314, US

(21) Appl. No.: 11/644,994

(22) Filed: Dec. 26, 2006

Related U.S. Application Data
(60) Provisional application No. 60/754,608, filed on Dec. 30, 2005.

(51) Int. Cl. H04M 11/00

(52) U.S. Cl. 455/552.1

(57) ABSTRACT

Telephony system includes base station and handsets. Base station includes radio transceiver for transmitting and receiving cordless telephone radio signals, and network connection for transmitting and receiving voice over internet protocol (VoIP) communications. Each handset includes a handset radio transceiver for transmitting and receiving cordless telephone radio signals. Base station converts received VoIP communications to cordless telephone radio signals and transmits converted cordless telephone radio signals through the base station radio transceiver. The base station includes navigation keys utilized as shortcut keys to base station features. The base station includes a “SORT” soft key and sorts call log records alphabetically when key pressed. The base station enables searching of call log records by entering name of caller. The base station and handsets each include directory records that accept alphanumeric characters for VoIP communication end point identifiers, such alphanumeric characters comprising letters, digits and special characters including @ and . (period) symbols.

### CROSS-REFERENCE TO RELATED APPLICATIONS

This application is entitled to the benefit of the filing date of U.S. patent application No. 60/754,608 entitled MULTI-HANDSET CORDLESS VOICE OVER IP TELEPHONY SYSTEM filed 30 Dec. 2005, the content of which is hereby incorporated by reference into the detailed description hereof.

### FIELD OF THE INVENTION

The invention relates to voice over internet protocol (VoIP) telephony.

### BACKGROUND OF THE INVENTION

In the telephony world, there has been and continues to be a great deal of effort expended on the development of phone equipment that can send and receive voice data over the Internet. This technology is typically referred to as “voice over internet protocol” or “VoIP”. Of the many terminating end points, fixed and mobile terminal products are “front and centre” in this development effort. On the mobile side, most groups are focused on delivering mobility using IP protocols directly. For instance, many mobile units communicate wirelessly using a standard data network protocol such as 802.11a/b/g. Alternative methods are desirable.

### SUMMARY OF THE INVENTION

In a first aspect the invention provides a telephony system including a base station and at least one handset. The base station includes a base station radio transceiver for transmitting and receiving cordless telephone radio signals, and a network connection for transmitting and receiving voice over internet protocol (VoIP) communications. Each handset includes a handset radio transceiver for transmitting and receiving cordless telephone radio signals. The base station is for converting received VoIP communications to cordless telephone radio signals and transmitting converted cordless telephone radio signals through the base station radio transceiver. The base station is also for converting cordless telephone radio signals received through the base station radio transceiver to VoIP communications and transmitting converted VoIP communications through the network connection. Each handset is for receiving cordless telephone radio signals from the base station through the handset's radio transceiver and for transmitting cordless telephone radio signals through the handset's radio transceiver to the base station.

The base station may include a VoIP processor and control unit for encoding and decoding VoIP communications using at least one selected codec. The base station may include at least one human interface device (HID) and the VoIP processor and control unit may also be for controlling the least one base station HID. The HIDs may include a keypad and handset. The HIDs may include a microphone and speaker. The HIDs may include a display. The display may be an LCD screen.

The base station may include non-volatile memory and the VoIP processor and control unit may control the non-volatile memory. The base station may include volatile memory and the VoIP processor and control unit may control the volatile memory.

The base station may include a base band processor connected between the VoIP processor and control unit and the base station radio transceiver. The VoIP processor and control unit may transmit voice data decoded from received VoIP communications and transmit the voice data to the base band processor to encode that data in accordance with cordless telephone protocols to produce cordless telephone radio signals for transmission through the base station radio transceiver.

The base band processor may be also for transmitting voice data decoded from cordless telephone radio signals received through the base station radio transceiver to the VoIP processor and control unit for encoding in accordance with VoIP.

The base band radio transceiver may be connected to a receive/transmit switch that is connected through a band pass filter to an antenna. The network connection may be an Ethernet connection.

Each handset may include a handset microprocessor, a handset base band processor and at least one handset HID. The base band processor is connected to the handset radio transceiver and decodes voice data from received cordless telephone radio signals and encodes voice data in accordance with a cordless telephone radio protocol. The base band processor is connected to the handset microprocessor for decoding voice data from received cordless telephone radio signals. Voice data by the base band processor is converted to sound through at least one HID and voice data is converted from sound by at least one HD are encoded by the handset base band processor.

The network communications may be G.711 or G.723.1 encoded and the cordless telephone radio signals may be G.729 encoded.

The base station may include a base station line-processing engine that handles call progress and monitoring. The base station line processing engine may include line objects responsible for managing aspects of a call including start up, steady state, hold, conference, and tear down.

The base may include an event processor that handles events generated by the system.

The base station may include a cordless extension engine that handles binding one or more handsets to one or more base station line objects.

The base station may include a media engine responsible for handling voice data. The media engine may include at least one codec. The media engine may include a plurality of codecs, at least one digital to analog converters (DACs), and at least one analog to digital converters (ADCs). The media engine may include at least one conference engine and one or more echo cancellers. The media engine may include a handsfree block.

The media engine may include two available streams, one stream for base station calls and one stream for handset calls. Both available streams may be used by a handset or the base station for conference calling. The media engine may include one available stream for the base station and each handset, such that the base station and each handset may have its own separate call. The media engine may include two available streams for the base station and each handset, such that the base station and each handset may have its own conference call.

The base station and handsets may each comprise directory records that can be used to make calls. The directory records may be public or private, and each public record may be broadcast from the base station to the handsets, and the handsets may add records to a handset directory record database when the handset is within range of the base station and the record is broadcast. When a public record is displayed an icon may indicate that the record is public. The icon may be a large (as compared to other text on the display) bold “P” to indicate the record is public.

The base station may include navigation keys on the base station, and the navigation keys may be utilized as shortcut keys to phone features during a base station idle state. The base station may include a “SORT” soft key, and the base station may sort call log records alphabetically when the SORT soft key is pressed. The base station may enable searching of call log records by entering the name of the caller as it might appear in the call log records.

The base station may include a full set of supported codecs for VoIP, and a reduced set of supported codecs for VoIP to maintain available resources for service of concurrent calls.

The base station may support remote configuration from a network client connected to the base station through the network connection. The system may provide remote configuration of feature keys in the system through a web page served up from the base station.

The system may provide that calls in the system can be marked public or private, and the base station may not permit handsets to join a call that is marked private.

The system may provide that directory records accept alphanumeric characters for VoIP communication end point identifiers, such alphanumeric characters comprising letters, digits and special characters. The special characters may comprise @ and . (period) symbols.

The base station may include a hold engine to simulate analog telephone hold behaviour. The hold engine may be for marking a line as held if more than one cordless extension is on the call when an extension requests to be held and updating the state of that extension.

In a second aspect the invention provides a telephony base station including a network connection for transmitting and receiving voice over internet protocol (VoIP) communications, and at least one human interface device (HID). The base station is for processing sound received through the at least one human interface device and converting the sound to VoIP communications for transmission through the network connection and for processing VoIP communications received through the network connection and converting the VoIP communications to voice data for transmission through the at least one human interface device. The base station includes navigation keys on the base station. The navigation keys are utilized as shortcut keys to base station features.

In a third aspect the invention provides a telephony base station including a network connection for transmitting and receiving voice over internet protocol (VoIP) communications, and at least one human interface device (HID). The base station is for processing sound received through the at least one human interface device and converting the sound to VoIP communications for transmission through the network connection, and for processing VoIP communications received through the network connection and converting the VoIP communications to voice data for transmission through the at least one human interface device. The base station includes a “SORT” soft key, and the base station sorts call log records alphabetically when the SORT soft key is pressed.

In a fourth aspect the invention provides a telephony base station including a network connection for transmitting and receiving voice over internet protocol (VoIP) communications, and at least one human interface device (HID). The base station is for processing sound received through the at least one human interface device and converting the sound to VoIP communications for transmission through the network connection, and for processing VoIP communications received through the network connection and converting the VoIP communications to voice data for transmission through the at least one human interface device. The base station enables searching of call log records by entering the name of the caller as it might appear in the call log records.

In a fifth aspect the invention provides a telephony base station including a network connection for transmitting and receiving voice over internet protocol (VoIP) communications, and at least one human interface device (HID). The base station is for processing sound received through the at least one human interface device and converting the sound to VoIP communications for transmission through the network connection, and for processing VoIP communications received through the network connection and converting the VoIP communications to voice data for transmission through the at least one human interface device. The base station and handsets each include directory records that can be used to make calls. The directory records accept alphanumeric characters for VoIP communication end point identifiers, such alphanumeric characters comprising letters, digits and special characters.

The special characters may include @ and . (period) symbols.

These and other aspects of the invention, including methods thereof, will be evident from the detailed description and FIGS. of the preferred embodiments provided herein.

### BRIEF DESCRIPTION OF THE DRAWINGS

For a better understanding of the present invention and to show more were clearly how it may be carried into effect, reference will now be made, by way of example, to the accompanying drawings in which:

FIG. 1 is a diagram of a cordless IP telephony system in accordance with a preferred embodiment of the present invention;

FIG. 2a is a block diagram of a base station in the system of FIG. 1;

FIG. 2b is a block diagram of a handset in the system of FIG. 1;

FIG. 3 is a device view of the base station of FIG. 2a;

FIG. 4 is a software module view of the base station of FIG. 2a;

FIG. 5 is a detailed view of software modules in the base station of FIG. 2a;

FIG. 6 is a base station line processing engine software module in the base station of FIG. 2a;

FIG. 7 is a cordless extension engine software module in the base station of FIG. 2a;

FIG. 8 is a media engine software module in the base station of FIG. 2a;

FIG. 9 is a state-output diagram of a directory record edit in the base station of FIG. 2a;

FIG. 10 is an example screen shot of user interface elements for a directory record edit in the base station of FIG. 2a;

FIG. 11 is an example display with navigation cluster in the base station of FIG. 2a;

FIG. 12 is an event-flow diagram of a quick access feature in the base station of FIG. 2a;

FIG. 13 is a callers list header display with “Sort” key in the base station of FIG. 2a;

FIG. 14 is a state-flow diagram of stages of a possible sort on callers list in the base station of FIG. 2a;

FIG. 15 is an event-flow diagram of components used to implement a sort/search function of a callers list in the base station of FIG. 2a;

FIG. 16 is a flow diagram for dynamic codec selection in the base station of FIG. 2a;

FIG. 17 is a block diagram of codec control components in the base station of FIG. 2a;

FIG. 18 is an example of programmable keys on a top part of the base station of FIG. 2a;

FIG. 19 is a diagram of components for feature key management used in the base station of FIG. 2a;

FIG. 20 is a block diagram of a cordless handset processing a soft (programmable) key press into an internal or stimulus event in a handset of FIG. 2b;

FIG. 21 is a state-flow diagram of feature key (f-key) processing logic in a handset of FIG. 2b;

FIG. 22 is a state-flow diagram of feature key programming logic in a handset of FIG. 2b;

FIG. 23 is a simplified block diagram of components involved for programming feature keys in a handset of FIG. 2b;

FIG. 24 is a web page interface implementation for the base station of FIG. 2a;

FIG. 25 is a state-output diagram of public/private call logic in the base station of FIG. 2a;

FIG. 26 is a diagram of simplified network connections and components for making SIP URI based calls on the Internet;

FIG. 27 is a directory number editing state-flow diagram in the base station of FIG. 2a;

FIG. 28 is a state-flow diagram of analog hold simulation; and

FIG. 29 is a block diagram of held call simulation components in the base station of FIG. 2a.

### DETAILED DESCRIPTION OF THE PREFERRED EMBODIMENT

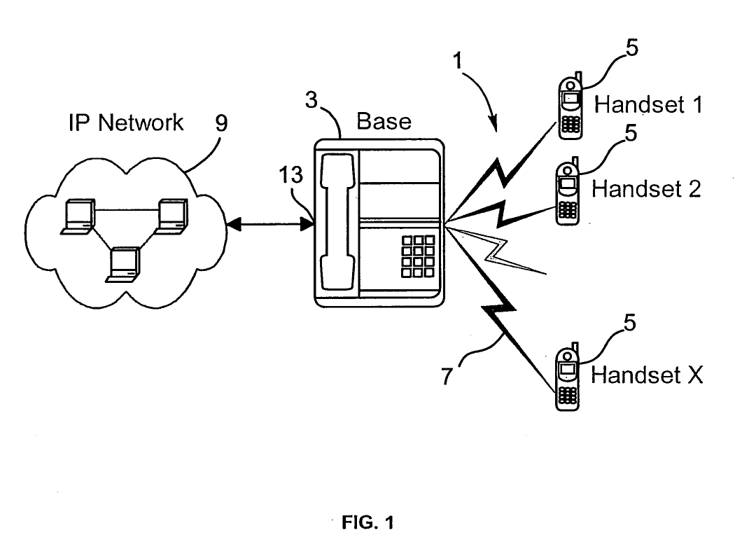

Referring to FIG. 1, an IP telephony system 1 has a base station 3 and one or more handsets 5. The base station 3 merges cordless phone technologies for a cordless link 7 with standard Internet protocols for access to an IP network 9 to which the system 1 is connected. The system 1 provides cordless remote handsets 5 with cordless phone performance and voice over IP features to provide cordless Internet calling. The use of cordless phone technologies can provide robustness, power efficiency, and excellent voice quality, while voice over IP can provide feature richness. Cordless phone technologies include, for example, those in accordance with the Digital Enhanced Cordless Telephone standard and its protocols.

A base station radio transceiver 11 transmits and receives cordless telephone radio signals, while a network connection 13 transmits and receives voice over internet protocol (VoIP) communications. Each handset 5 has a handset radio transceiver 15 for transmitting and receiving cordless telephone radio signals. The base station 3 converts received VoIP communications to cordless telephone radio signals and transmits converted cordless telephone radio signals through the base station radio transceiver 11. The base station 3 also converts cordless telephone radio signals received through the base station radio transceiver 11 to VoIP communications and transmits converted VoIP communications through the network connection 13. Each handset 5 receives cordless telephone radio signals from the base station 3 through the handset radio transceiver 15 and for transmits cordless telephone radio signals through the handset radio transceiver 15 to the base station 3.

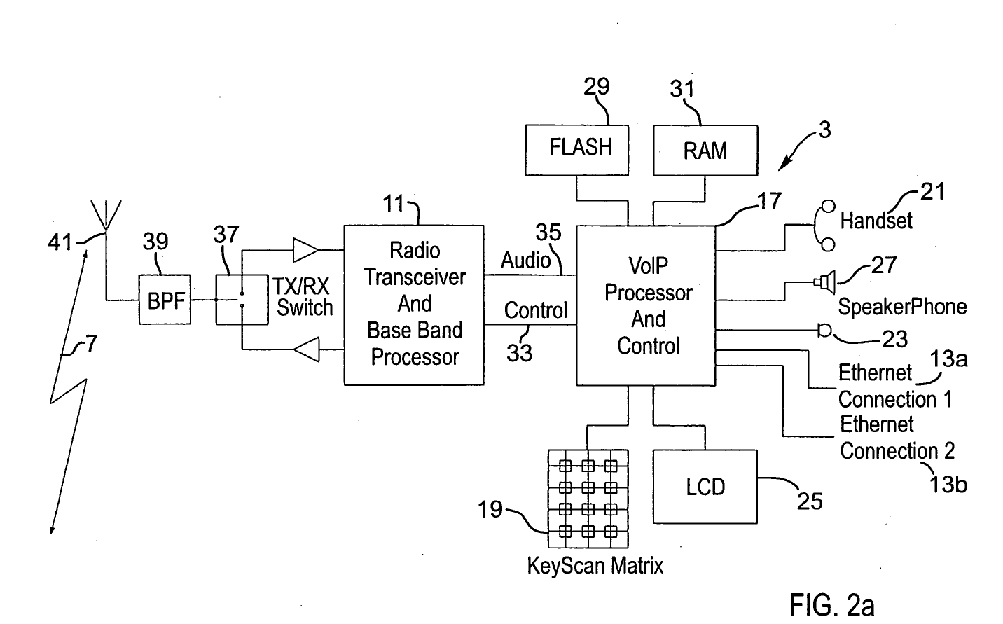

Referring to FIG. 2a, in terms of physical device layout the base station 3 has a VoIP processor and control unit 17 connected to human interface device (HID) inputs (for example a keypad 19, handset 21 and microphone 23), HID outputs (for example LCD screen 25, handset 21 and speaker 27), and memory (eraseable programmable non-volatile memory 29, for example flash memory, and random access memory or RAM 31). The unit 17 is also connected to a cordless technology radio transceiver and base band processor 11. In this example a radio transceiver and base band processor 11 are shown as integrated; however, they could be provided as discrete components. The unit 17 and processor 11 communicate via a control path 33 and a voice data path 35. The processor 11 is further connected to a transmit/receive switch 37. The switch 37 is connected through a band pass filter 39 to an antenna 41. The unit 17 is connected to two Ethernet connections 13a, 13b that provide the IP connection 13 of FIG. 1. One or more Ethernet connections could be used in the base station 3.

Referring to FIG. 2b, each handset 5 also has a cordless telephone radio transceiver and base band processor 15. In this example a radio transceiver and base band processor 15 are shown as integrated; however, they could be provided as discrete components. The processor 15 communicates with a microprocessor 43 via a control path 45 and a voice data path 47. The processor 15 is further connected to a transmit/receive switch 48. The switch 48 is connected through a band pass filter 49 to an antenna 51. The microprocessor 43 is connected to HID inputs (for example a keypad 53), HID outputs (for example an LCD screen 55), and memory (eraseable programmable non-volatile memory 57, and random access memory or RAM 58). Other HID inputs (for example microphone 59) and HID outputs (for example speaker 61) are connected to the processor 15. Connecting speaker 61 and microphone 59 to the processor 15 exploits these capabilities in the base band processor 15 requiring a less powerful microprocessor 43 with less complex software. If desired, for example, if these capabilities are not available in the base band processor 15 then the microphone 59 and speaker 61 could be driven through the microprocessor 43. Similarly the base band processor 11 of FIG. 2a could be used to drive HID inputs and outputs; however, these capabilities are usually built into available VoIP processor and control units where most processing is already occurring as will be evident from the description herein.

It will be recognized by those skilled in the art that alternative physical device layouts could be used to achieve the features and functions described herein. For example, the radio transceiver and base band processor 11, 15 could be provided as separate integrated circuits. Preferably, the radio transceiver and base band processor 11, 15 are provided as a single integrated circuit for ease of implementation, lower cost, smaller size and energy efficiency. As a further example, the handset radio transceiver and base band processor 15 and the handset microprocessor 43, and the base station radio transceiver and base band processor 11 and VoIP processor and control unit 17, could be provided as integrated components respectively; however, it is advantageous to provide these as separate components to take advantage of existing integrated circuits dedicated to similar functions.

The VoIP processor and control unit 17 used in the preferred embodiment is a microprocessor containing dedicated functionality for VoIP applications. Many such units are available in the marketplace, including for example those provided by Broadcom Corporation of Irvine Calif. Various radio transceiver and base band processor integrated circuits 11, 15 are also available in the marketplace, including for example those provided by National Semiconductor Corporation of Santa Clara, Calif. Many general purpose microprocessors could perform the functions of microprocessor 43.

The base station 3 converts a voice stream (of voice data) arriving on IP connection 13 into a voice stream compatible with cordless telephone technology used by the radio transceiver and base band processor 11. For example, a G.711 encoded voice stream received by the base station 3 at an IP connection 13, for example Ethernet connection 113a or Ethernet connection 213b, is converted to a G.729 encoded voice stream for transfer over a cordless link 7 and vice versa. It is not required to use these specific codec transformations. Other codec transformations between a voice stream encoded for IP and a voice stream encoded for cordless telephones could be applied as required.

This can resolve latency issues for wireless voice links as cordless telephone radio technology is designed for real-time traffic such as voice streams. For instance, contention issues do not need to be dealt with in a voice stream encoded for cordless telephones because access to a cordless telephone link is more tightly controlled than an IP connection.

Additionally, data rates of cordless telephone technologies are typically much lower than IP connections, which result in a more robust wireless link that is less susceptible to interference. Also, control protocols for cordless telephone technologies are optimized for voice traffic, handset transceivers can remain powered down for longer periods of time when not in use and thereby provide much better standby battery performance.

The base station 3 controls the flow of voice data between the network 9 and cordless handsets 5. In addition to handling call control for base station 3 calls, it also handles call control for calls in progress on the cordless handsets 5.

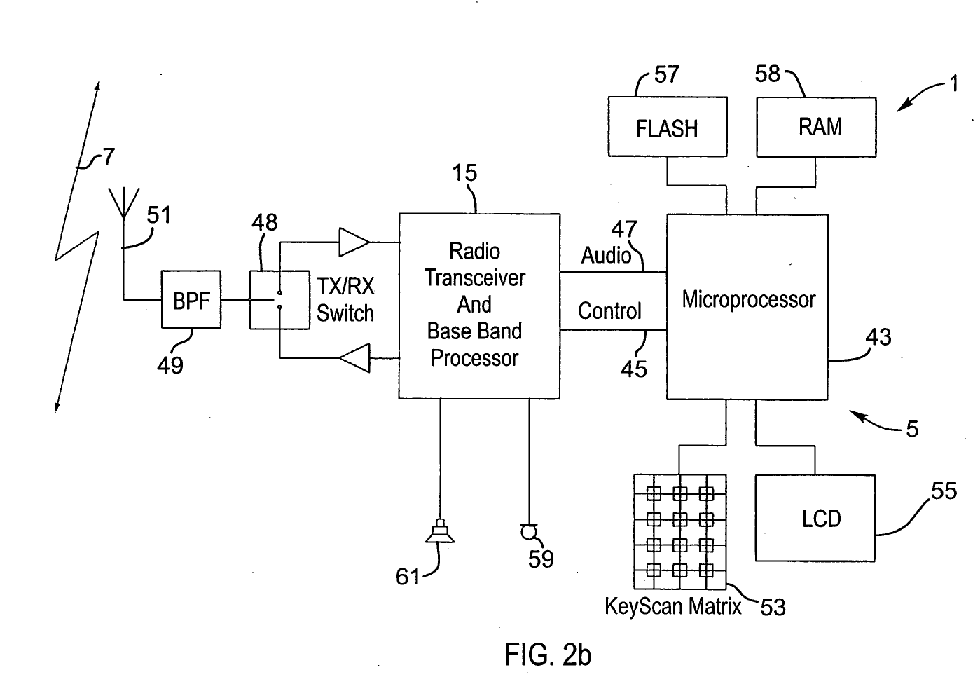

Referring to FIG. 3, when viewed from an alternative physical (hardware) level the base station 3 has a network connection 13 (PHY), an MCU (micro controller unit) 63, an optional DSP (digital signal processor) 65, a radio module 67, HID devices 69 (such as speakers, microphones, buttons (or keys), LEDs (light emitting diodes), and a display). The above devices move voice data back and forth in the system 1. For instance, the MCU 63 receives network data from the network interface (PHY) 13, extracts voice data, and sends it to the DSP 65 for signal processing. This processing includes decoding from the encoding that was used (such as G.711 or G.723.1). Any required manipulations also occur in the DSP 65 before the data is either converted to analog form or left in digital form and sent to the radio module 67 or the HID devices 69 within the base station 3. Similarly, the reverse occurs for sending voice data. The HID devices 69 produce analog or digital voice streams that go to the DSP 65 for encoding and other processing and, subsequently, deliver that modified and digitized voice stream to the MCU 63 for packetizing and, finally, transmission. The MCU 63 and DSP 65 perform the functions of the unit 17 of FIG. 2a. The radio module 67 incorporates the radio transceiver and base band processor 11, switch 37, band pass filter 39 and antenna 41.

As discussed previously, it is recognized that the hardware functionality of FIG. 3 can be provided by integrated physical devices as described with respect to FIGS. 2a and 2b; however, as mentioned previously, the hardware functionality can be spread out over different physical devices.

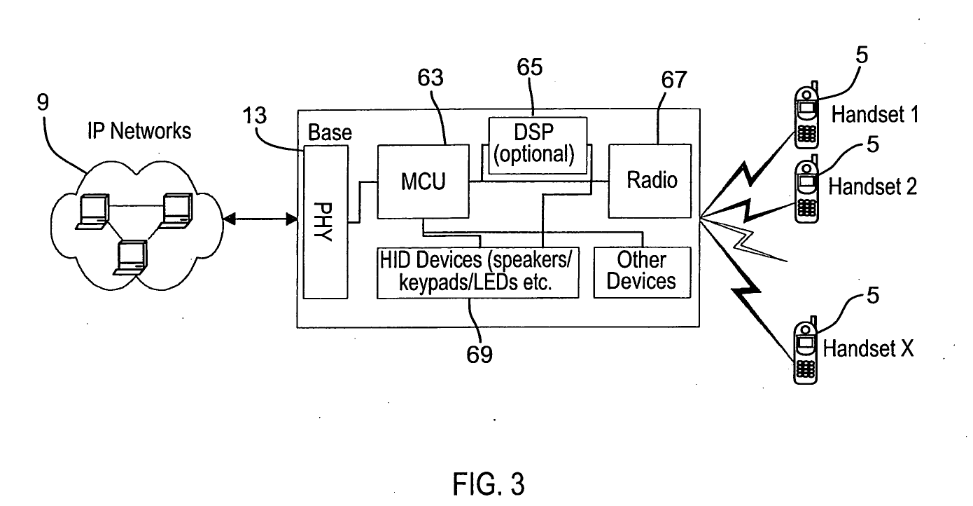

Referring to FIG. 4, from a software perspective the base station 3 has a base station line processing engine 71 that handles all aspects of call progress and monitoring. Additionally, the base station 3 has cordless extension engine 73, media engine 75, services 77, and device drivers 79. Focussing primarily on the base station line processing engine 71, cordless extension engine 73, and media engine 75, these software modules are discussed in more detail below. The software will be stored in non-volatile memory, for example memory 29 (FIG. 2a) which may integrated with the MCU 63 or provided separately. The software is accessed by the MCU 63 to provide the base station functionality described herein. Correspondingly, software for local handset functionality is stored in memory 57 (FIG. 2b) and accessed by the microprocessor 43 to provide the local handset functionality described herein. As will be recognized by those skilled in the art, much of the functionality of the system 1 may be provided by using more hardware and less software, or more software and less hardware. The balance between hardware and software is to some extent, after using the principles described herein, a design choice dependent on available hardware, cost, time and other such design considerations.

The following modules are responsible for managing call resources for both the base station 3 calls and the cordless handset 5 calls. Provided that there are sufficient resources in the system 1, the system 1 can support equal access for the base station 3 and all handsets 5. For instance, if there were four handsets 5 registered to the base station 3 then the system 1 is capable of four radio links or full duplex channels 7 and five full duplex voice streams at the IP connection 13—at a minimum. This capability allows all four handsets 5 and the base station 3 to be on a distinct call at the same time. This capability extends out to handsets 5, radio links or channels 7, and voice streams as desired and resources permit. Additionally, more than one link or channel 7 for each cordless handset 5 can be provided so that independent handset 5 hosted conferences can take place.

Where resources are limited, there will typically be a limit on the number of simultaneous radio links or channels 7 that can be supported as well as a limit on the number of voice streams that can be supported at the base station 3. For example, in one implementation of the base station 3 and handsets 5 provided by Aastra Telecom of Toronto Canada as model 480iCT the system 1 is limited to two VoIP voice streams and thus one conference call active at any time. Also, only one distinct cordless call link 7 is available; however, other cordless handsets 5 can join that one call.

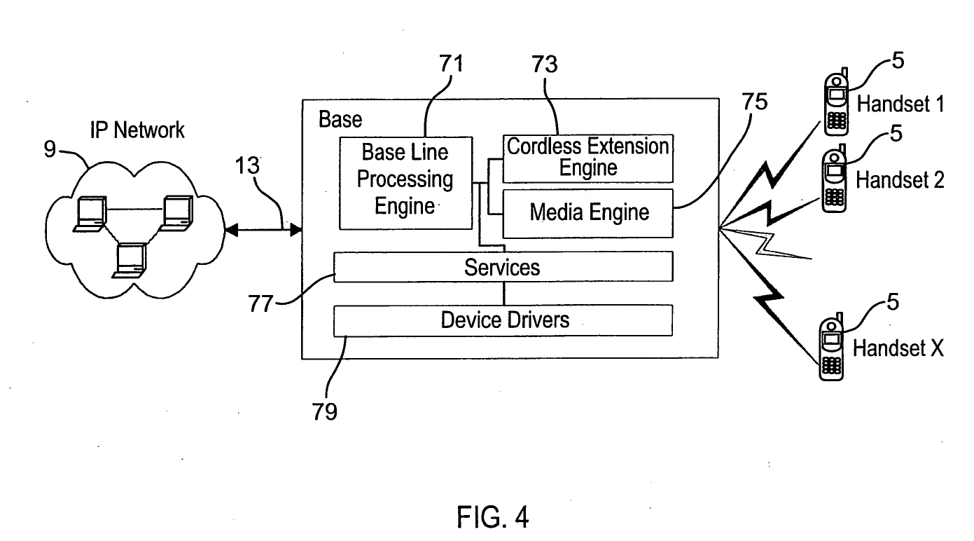

Referring to FIG. 5 additional detail for the base station line processing engine 71 and the cordless extension engine 73 is provided. A VON Stack 77 is a voice over network stack 77. A HID Stack 79 is a human interface device stack 79.

The base line processing engine 71 has three main components: an event processor 81, line objects 83, and special functionality handlers 85 such as conference and transfer.

The line objects 83 are responsible for managing all aspects of a call including start up, steady state, hold, conference, and tear down. During call startup, a line object 83 manages resources required to make and maintain the call. This may include interfacing with a communication protocol stack (or VON stack) 77, reserving voice data resources such as a codec (through media engine 75), managing a user interface (such as display 55 and managing transducers such as a speaker 27 and microphone 23 (through services 77 layer including a media stack 87, the HID stack 79, VON stack 77, and radio stack 89 and device drivers including speaker/microphone driver 91, keypad, display and other non-transducer HD device driver 93, network interface driver 95 and radio driver 97. Other services and device drivers may be provided as required or desired for devices in the base station 3. During call teardown, the reverse is true. All the reserved resources are released, the display 25 is updated, transducers 21, 23, 27 are neutralized, and appropriate messaging is sent through the communication protocol (VON) stack 77 to signal the other party (and its VoIP telephony device) to the call. Again, it will be recognized by those skilled in the art that alternative system architectures could be used to provide the features and functionality described herein as may be desired by the system designer or driven by the physical components to be used.

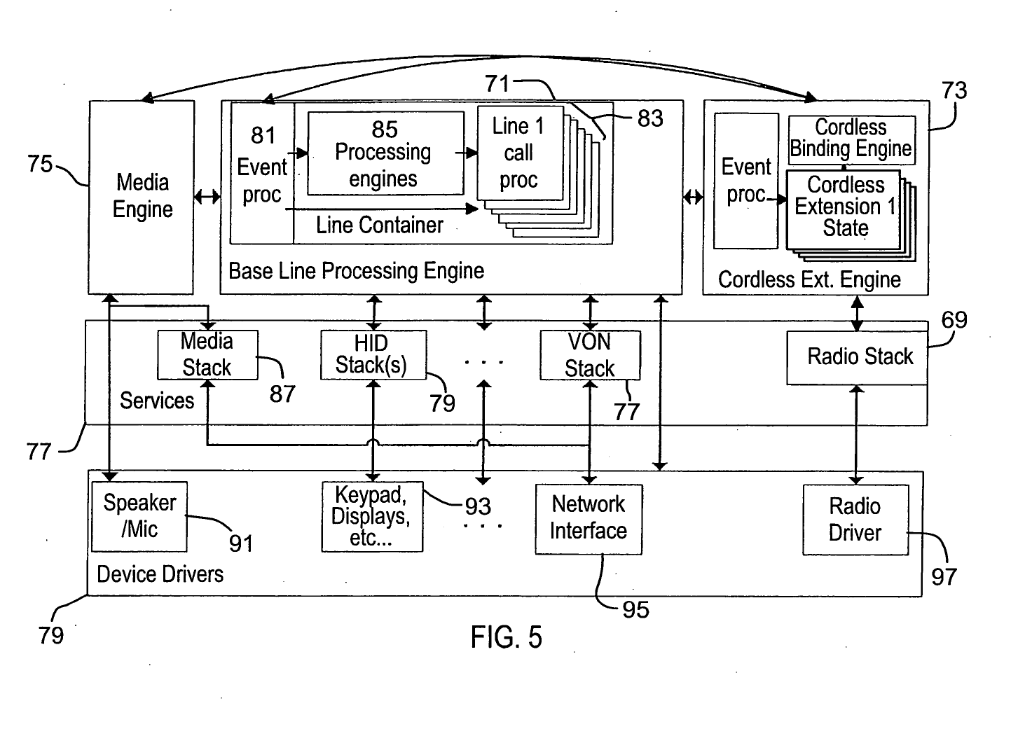

Referring to FIG. 6, the base line processing engine 71 has multiple line objects 83. Each line object 83 is associated with a single call. Some implementations may bind a single line object 83 to two calls that have been joined in a conference call—as is the case with the 480iCT implementation referred to earlier.

As mentioned previously, the base line processing engine 71 also has an event processor 81 that handles events generated by the system 1. The event processor 81 receives the events and determines where the events need to go. As will be evident to those skilled in the art, an event processor 81 can be implemented in a variety of ways and, as such, specific detail of the event processor 81 will not be discussed further herein.

Various event handling engines 85 handle the events before the events are provided to the line objects 83 for processing and state tracking. A call event engine 85a processes call events. There are other features that may be available. Features such as conference and transfer are commonly desired, and are provided by conference engine 85b and transfer engine 85c. For example, the 480iCT implementation mentioned previously does provide conference and transfer on the base station 3 and handsets 5 for non-intercom calls (an intercom call herein is defined as a call between the base station 3 and a handset 5 or between two handsets 5). The event handlers 85 intercept the events and work semi-independently from the line objects 83. The event handlers provide necessary extra control, resource reservation, and user interface that are not typically part of a call as an end point terminal such as a telephone will generally only support one conference and/or one transfer at a time—as is the case in the 480iCT. The functionality of the event handlers 85 can be built into the line objects 83 if desired. The use of event handlers 85 lends itself to incorporation into already existing designs for VoIP base stations that utilize line objects and wish to add features and functionality described herein. It is to be recognized that the software has been described with respect to line object that may be implemented using object oriented program; however, it is not necessary to use object oriented programming to provide the features and functionality described herein. Other programming methods can provide similar features and functionality.

In a non-limited system 1, multiple conferences are possible, as are multiple transfers. Every handset 5, and the base station 3, is able to maintain an independent conference or effect a simultaneous transfer on their independent calls.

A separate hold engine 85d handles interaction between the cordless handsets 5 and the base station 3 lines. When either the base station 3 or the cordless handset 5 places a call on hold, either party can retrieve it.

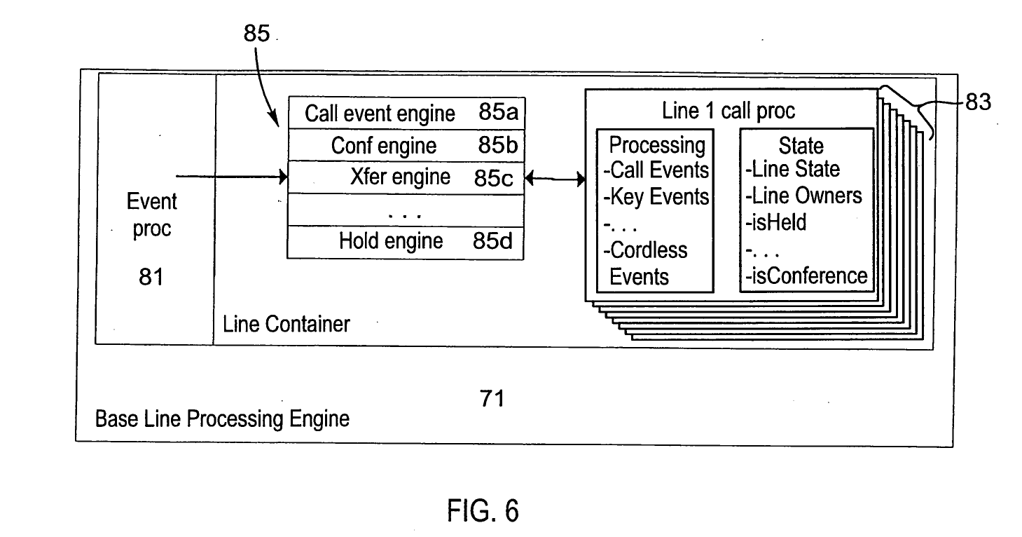

Referring to FIG. 7, the cordless extension engine 73 mainly acts as a stimulus interpreter, handset state tracker, and binding mechanism to a base station line object 83. As for the base line processing engine 71, an event processor 87 processes events. A cordless binding engine 89 handles binding one or more cordless extensions to one or more base station line objects 83. As will be further described, this engine 89 also augments the hold engine 85d functionality of the base station line engine 71 to allow analog hold simulation for handsets 5.

The cordless extension engine 73 allows for a degree of function extensibility for the cordless handsets 5. Thus, handset 5 functionality is not completely fixed by the programs on the handsets 5 themselves.

Other functions of this engine 73 include handling radio error situations and state updates. Both base station 3 and handsets 5 have a variety of states depending on the operating condition of the base station 3 and handsets 5 at any one time. Features and functions available at any time will depend on the state of the base station 3 or handset. Some of aspects of states specifically applicable to the features and functions described herein will be referenced in this description. The cordless binding engine 89 updates a state object 91 for each handset 5. State updates to various handsets 5 can be handled in a variety of ways. For example, in a Public/Private feature (to be discussed further below) when a line on the base station 3 is marked “private” the cordless extension engine 73 is responsible for notifying all applicable handsets 5, which in the case of the 480iCT mentioned previously is only those handsets 5 that are actively using that line.

The functionality and features of the system 1 can be enhanced in many ways, particularly by including additional intelligence in the cordless extension engine itself, and in the degree of coupling between the base station line processing engine and the cordless extension engine. The more each engine knows about the other, the more intuitive the user interface can become. However, additional coupling can limit the ease of extensibility of the system 1 in general.

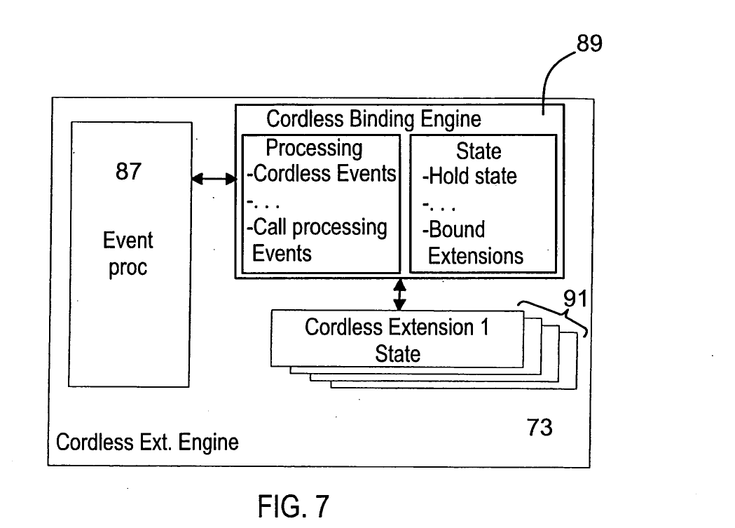

Referring to FIG. 8, the media engine 75 is responsible for handling the voice data. The media engine 75 has one or more encoder/decoders, also known as codecs 93, one or more digital to analog converters (DACs) 95, one or more analog to digital converters (ADCs) 97, one or more conference engines 99 and a mixer 101 (if conference is to be supported), and one or more echo cancellers (ECAN) 103. If handsfree is to be provided, then a handsfree block is also required—either full or half duplex. Other features that can be provided include automatic gain control (AGC) 105, equalization (EQU) 107, and side tone (feedback of talker's voice into the receive path—simulates an analog phone) 109.

In the 480iCT implementation mentioned previously, there are two voice streams available. One is used for base station 3 calls and one is used for handset 5 calls. However, if either the base station 3 or a handset 5 sets up a conference call, then both streams are used for that call and the other side of the system 1 (base station 3 or handset) is prevented from making or receiving calls until the conference is terminated or broken.

For a system 1 to be non-blocking, the media engine 75 has one stream for each device (base station 3 or handset 5) that is to maintain an independent call. For example, for one base station 3 and four handsets 5, the media engine 75 has a minimum of five streams in order to ensure every user can make or receive a call. To allow a conference on each handset 5 and the base station 3, then the media engine 75 has a minimum of ten streams. As the system architecture is modular, adding streams is a matter of adding the necessary resources. For instance, increasing the processing power (typically measured in million instructions per second or MIPS) of the DSP 65 (FIG. 3) or adding hardware codecs are ways to provide for the extra streams. The call control residing in the base station line processing engine 71 can be scaled to control these extra streams.

The media engine 75 connects to the system transducers where sound is received and/or produced by the system 1, for example, a handset 21, a speaker 27, a microphone 23, a headset 111, and radio module 67 (the cordless extension engine, radio stack, and radio driver for eventual sound production at the handset transducers 61, 59). The number of digital-to-analog converters (DACs) 95 and analog-to-digital converters (ADCs) 97 required directly depends on the number of transducers that are to be simultaneously connected. Switches and multiplexers (MUXs), not shown, can be used to reduce the number of DAC's 95 and ADC's 97 required. This architecture reduces the flexibility of the system 1 but may also reduce the cost.

In the 480iCT implementation referred to earlier, the radio module 67 connection is via an analog transmit and receive signal. There is only one DAC 95 and one ADC 97 dedicated to the radio module 67 and, therefore, the maximum possible radio channels 7 that can be supported is limited to one.

To make a non-blocking implementation with four handsets 5, four full duplex channels are supported between the radio module 67 and the media engine 75. This requires four DACs 95 and four ADCs 97 or a digital multiplexer scheme such as TDD (time division duplex) that allows for four distinct full duplex voice channels to be present. The preferred method of making these extra connections is by a digital means so that the voice data is not further degraded by multiple coding and decoding cycles.

Referring again to FIG. 5, an implementation of the base station 3 can be created using an existing voice over IP telephone hardware platform and adding to it hardware and supporting software. Software can also be included to integrate cordless call control, public directory, configurable feature key, and simultaneous cordless/corded call support.

Call control logic for the cordless functionality can be integrated into existing voice over IP telephone call control logic. This can allow for both the handset 5 and the base station 3 to operate as virtually complete and separate phones. This allows one to continue to be active when the other one is active. In the implementation that will be first discussed herein conference is an exception to the handset 5 and base station 3 acting as separate phones.

The call control logic resides in the base station line processing engine 71. The base station 3 is modified to include the cordless extension engine 73. Monitoring and control logic is included in the base station line processing engine 71 to interface with the cordless extension engine 73.

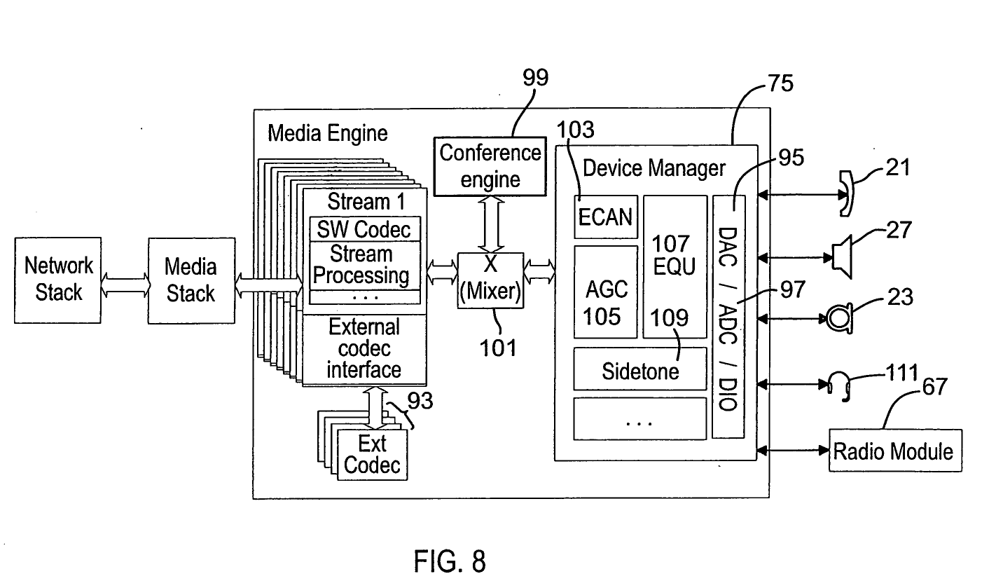

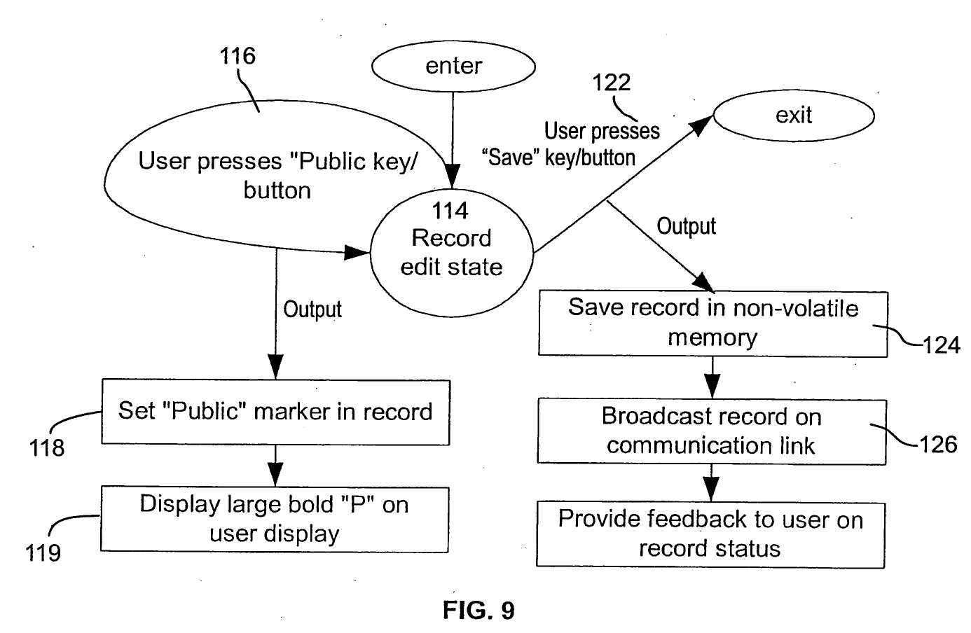

Referring to FIGS. 9 and 10, the base station 3 software stores directory records 113 that a user can use to make calls. Initially when a directory record 113 is entered it is private by default. The base station 3 permits the user to make a record 113 public. Once a record 113 is made public, it is broadcast from the base station 3 to the handsets 5 that are registered to the base station 3. Each handset 5 has corresponding software to add the record 113 to its handset directory record database when the handset 5 is within range of the base station 3 and the record 113 is broadcast.

In the preferred embodiment, to make a record 113 public, the user has two choices. First the record 113 can be marked public at the time it is entered in a record edit state 114. To do this the user presses a “Public” identifier key 115 during record entry 116. This can be a soft key (programmable button) or it can be a hard key (button) or a combination of keys. When a record 113 is made public the record 113 is marked 118 as public and when the user presses 122 a Save key 120 this marker (such as a bit in a status byte) is stored 124 back to non-volatile memory (such as EEROM 29, FIG. 2a) with the record 113. The record 113 is transmitted 126 to the other units (base station 3, if stored on a handset 5, and handset 5) in the system 1 for inclusion in their directories. Additionally, an icon 117 of some type can be displayed 119 on the base station display 55 to indicate that the record 113 is public. For example, the icon 117 can be a large (as compared to other text on the screen) bold “P” to indicate the record 113 is public. This icon 117 will be readily understood by users and its size and location provide a readily evident visual warning to users that the record 113 is public. Users will want to know if a record 113 is public particularly where the handsets 5 may be shared or accessible by multiple users.

Changes in public records 113 may affect more than the base station 3. At some point after the record 113 has been marked 118 as public, it is transmitted to the other units in the system 1 for inclusion in their directories. The base station directory feature can be provided with a “Sync” soft key that, when pressed, instructs the base station 3 to broadcast all public directory records 113 to ensure that handsets 5 are up to date.

To reduce the complexity of a directory implementation directory records 113 entered on a handset 5 may be limited to private and not shared with the base station 3. Alternatively, an implementation can allow for sharing of records 113 from a handset 5. Synchronization functions between multiple units (base station 3 and handsets 5), including algorithms to determine priority between units, can be included.

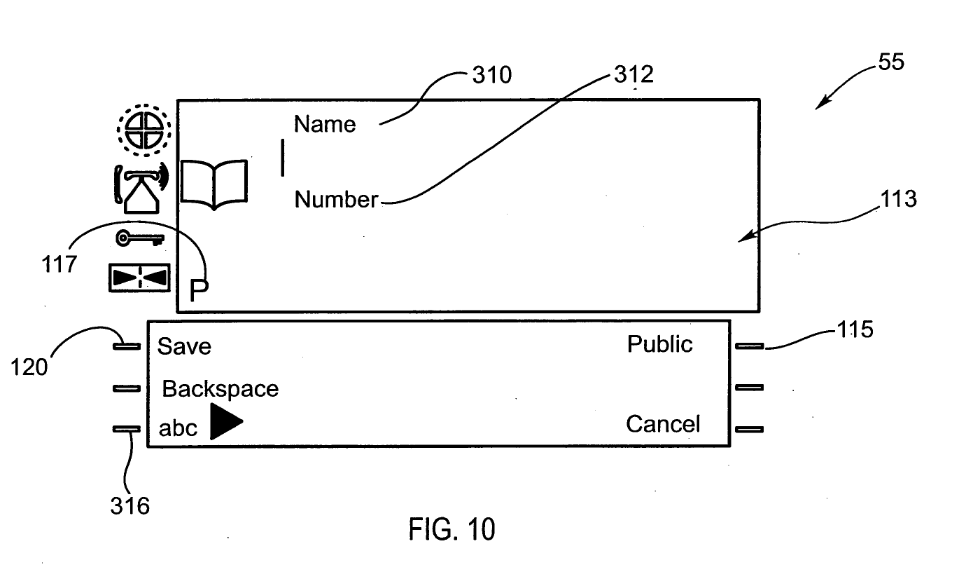

Referring to FIG. 11, in order to simplify or speed up access to features of a base station 3 from an idle state on the base station 3, a shortcut is provided that will put the user into the feature as quickly as if the user had pressed a dedicated key. The shortcut keys are navigation (up (▴) and down (▾) arrow) keys 128, 130 of a navigation cluster 132 on a front 134 of the base station 3. A navigation cluster 132 is commonly found on telephone products and typically is not labelled.

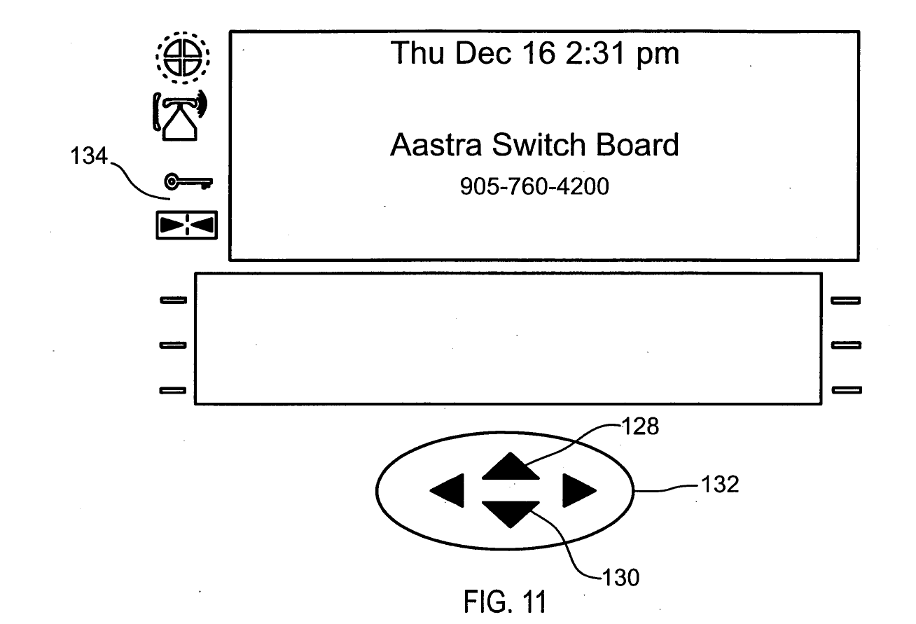

Referring to FIG. 12, to implement the shortcut feature a keyscan service (software module) 136 checks for user input 138 at the key pad 19, including navigation keys 128,130 and any softkeys and hardkeys on the base station 3. If there is input by a user at the keys 128, 130 then this is added 140 to an event queue. If the base station 3 is in an idle state 142 then if the event is an UP key 128 then the directory feature is accessed 144, and if the event is a DOWN key then the callers list feature is accessed 146.

The shortcut feature can be applied to a telephony base station 3 with or without the cordless handset 5 features described herein.

In the caller list feature (and also in a redial feature), the user can be provided with access call details such as the line on which the call was made or received and the duration of the call. This information can be accessed by pressing a “Details” soft key while viewing a record.

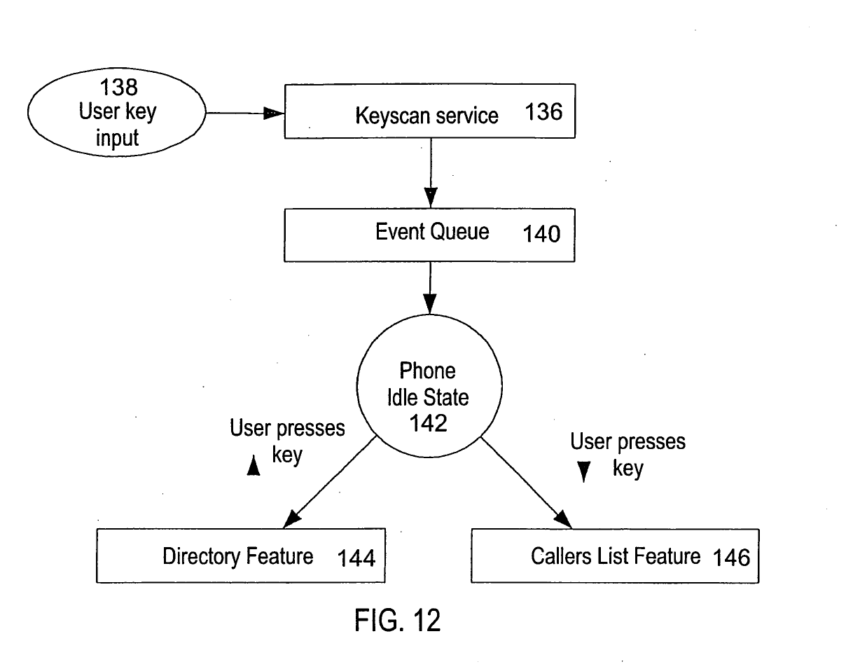

Referring to FIG. 13, a display with a “SORT” soft key 148 permits a user to view call log records alphabetically. The user sorts the list by pressing the “Sort” soft key 148 while viewing the caller's list header. To search the list, the user begins typing the name of the caller as it might appear in the list.

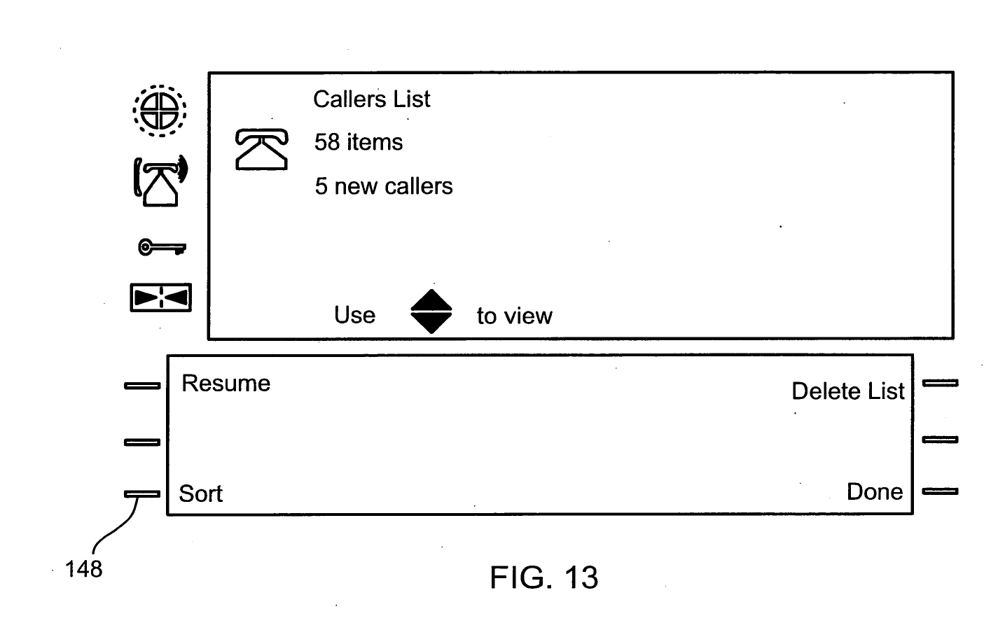

Referring to FIG. 14, an algorithm in the base station 3 software is used to display matches from call log records each time a letter is entered. When in the Callers list caller header state 150 if a user presses 152 the SORT key 148 then the callers list is sorted 154 and the base station 3 is returned to the Callers list header state 150. Alternatively, if the user pressed 156 an alphanumeric key then the list is sorted 158 and the caller record with the closest match 160 is displayed 162, and the base station 3 enters an Item View state. If there are no matches then the base station 3 is returned to the Callers list header state 150. If in the Callers header state 150 a user presses 164 a navigation key 128, 130 (UP or DOW) then the first or last caller (alphabetically or chronologically depending on the condition of the sort function), respectively, is displayed 166, and the base station 3 enters a Item View state 168.

If in the Item View state 168 the user presses 170 a navigation key 128, 130 (UP or Down) then the next callers record (alphabetically or chronologically depending on the condition of the sort function) in the direction of the key is displayed 172, and the base station 3 re-enters the Item View state 168. If the user presses 174 an exit (or done) softkey then the base station 3 exits 176 the Item View state 168 and the caller list function.

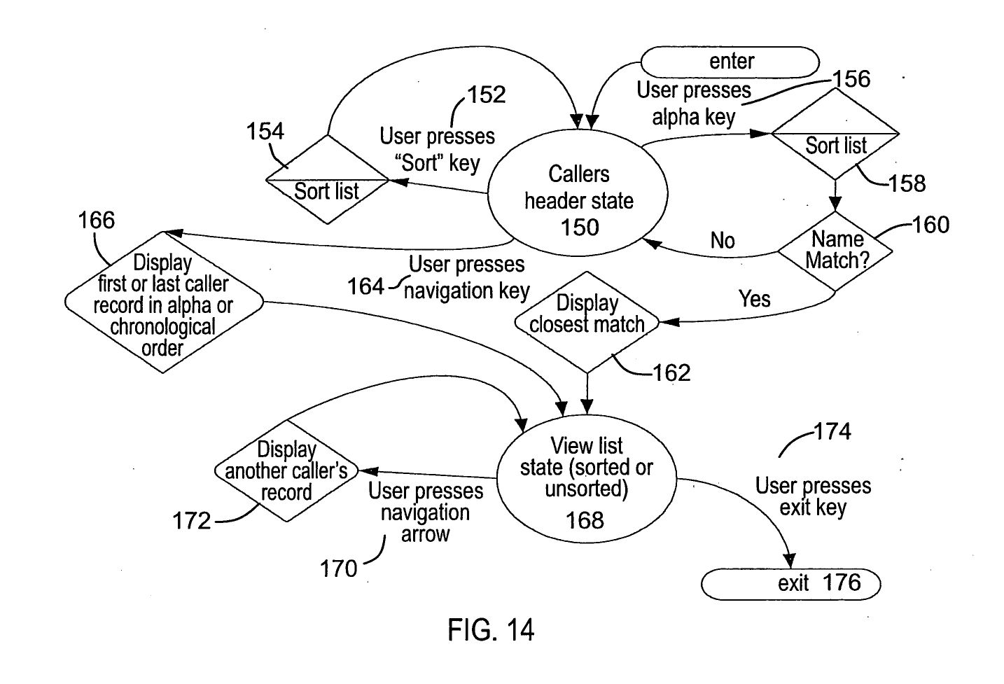

Referring to FIG. 15, to implement the sort and search function on the callers list the keyscan service 136 (software module) checks for user input 138 at the key pad 19. If there is input by a user at the keypad 19 then this is added to event queue 140. If the base station 3 is in a Callers list feature Header state 180 then if the event is a user press 181 of a SORT softkey 148 then a list sorting algorithm is accessed 182. If the base station 3 is in the Callers list feature Header state 180 or Item View state 184 then if the event is a user press 186 of an alphanumeric key on the keypad then the sorting algorithm is accessed 182 followed by access 188 of an alphanumeric search algorithm.

Call log records are often the easiest place for contact information for a caller to be found. Using a call log record a caller can be easily redialled without entering contact information. Using a sort feature, and possibly a search feature, a call log record for a particular caller can be quickly and easily identified. The user does not need to scroll through a chronologically listed log to see if a particular caller is in the log, and where.

A base station name editor and cordless handset editor are provided for their respective directories. In the preferred embodiment these editors are very similar. Each auto-capitalizes the first letter of each new word. As well, the entry mode can be selected using numeric, lower case alphabet, and upper case alphabet soft keys, for labelled as 123 [symbol] , abc [symbol] , and ABC [symbol] soft keys respectively.

The sort and search functions can be implemented on a telephony base station 3 with or without the cordless handset features described herein.

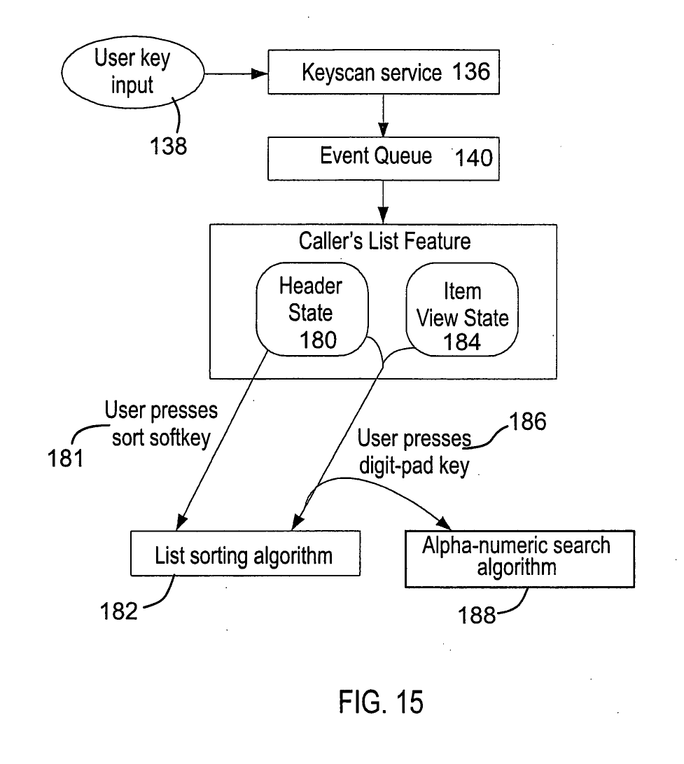

Referring to FIG. 16, where resources are limited on the base station 3, under certain circumstances, the available choice of voice codecs may be limited in order to provide service for concurrent calls. In order to have more than one call active at a particular time, for example one call on the base station 3 and one on a handset 5. A codec is required for each call. Where processing resources are limited, for example when using an existing processor for single line VoIP applications, it may not be possible to operate multiple high complexity codecs at the same time. A processor of greater capacity could be used.

Alternatively, a dynamic list of codecs may be used. Whenever a call is started the base station 3 will first check 200 to make sure that no other calls exist; if they do and they are using a high complexity codec, the base station 3 dynamically modifies 202 the supported codec list to only reflect lower complexity codecs. Thus, the base station 3 has at most one high complexity codec in use and reduced resource requirements for additional calls. As an example, very high complexity codecs include G.723.1. If no high complexity codec is in use then a full list of codecs is used 204.

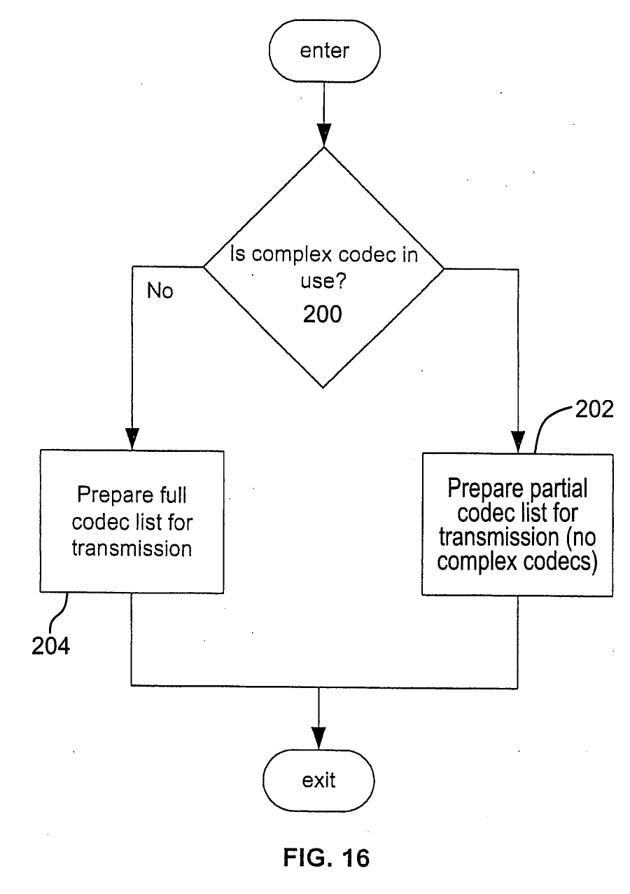

Referring to FIG. 17, the above may be implemented by having the base station 3 support a full set of voice codecs 210 for use during calls. If another call exists then a reduced set of codecs 212 will be supported. The alternate codec sets are stored in memory and made available to the media engine 73 when setting up calls. At the initiation of any given call, the base station 3 will exchange its codec capability with the caller (caller's IP telephony device) in the form of a preference-sorted set of supported codecs. The receiving endpoint will view the list of supported codecs of the initiating end point and select the highest preference codec that the receiver also supports. All SIP telephones must support G.711 at a minimum, which is a higher bit rate low complexity codec.

As G.711 does not offer significant compression alternate codecs in addition to G.711 may be provided that offer higher levels of compression and therefore a lower bit rate. This lower bit rate offering is generally more important in larger installations where the aggregate bit rate for many phones many be in excess of the current network capabilities. There generally is a trade off for the lower bit rate by way of compression complexity. Compression algorithms, no matter how trivial, require more processing resources than uncompressed media streams.

It is possible to use the design of some existing cordless handsets, such as an Aastra Telecom CB-16/3012, as a cordless handset 5 without hardware modification provided that the existing handset can be provided with revised software, for example, for additional desired functions described herein such as the feature keys, the directory feature (directory synchronization), and the intercom feature.

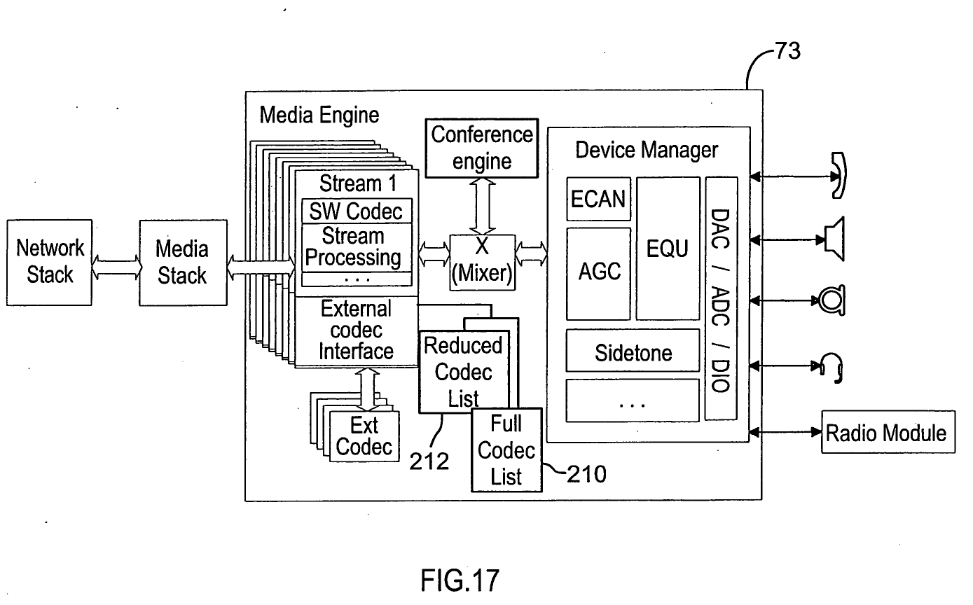

Referring to FIG. 18, programmable (“soft”) keys 220 are keys that are programmed to reflect the meaning of the key and the system 1 processes the key accordingly. An example base station 3 has programmable keys 220 on a top part 224 of the front of the base station 3. These keys 220 can be used, for example, as quick dial keys where a telephone number is programmed to them and the user presses a key 220 to either display or dial the number. Other functions that could be programmed to the programmable keys include for example: DND (do not disturb) toggle, station status (if led or LCD segment also tied to key), conference, transfer and other features and functions that have been described herein. These keys 220 may be used in a particular state of the base station 3 with labels displayed on the display 55 to reflect the function of the key 220 in a particular state. The keys 220 may also be used separate from a display 55 and have the same function in all states.

In this description, “feature keys” refers to a list of keys 220 on a cordless handset 5, allow the keys 220 may also be used in a similar manner on base station 3. Typically there will not be enough buttons on the handset 5 to allow for a hard key for each feature or function, such as line keys or features such as conference and transfer. These features are placed into a list and each entry in the list represents a virtual key. Activation of these features may be done remotely at a switch or KSU, not shown. The feature may be activated locally in the device. For example a remotely activated feature in the preferred embodiment is the line feature. Line connections require the logic located on the base station 3. Examples of locally activated features are the callers list and private/public calls.

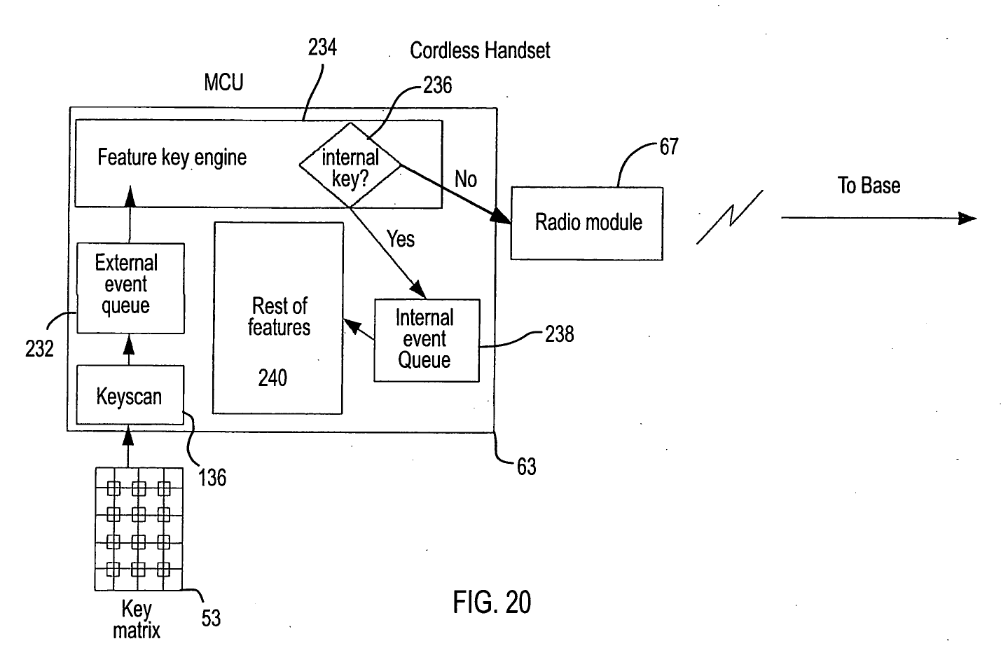

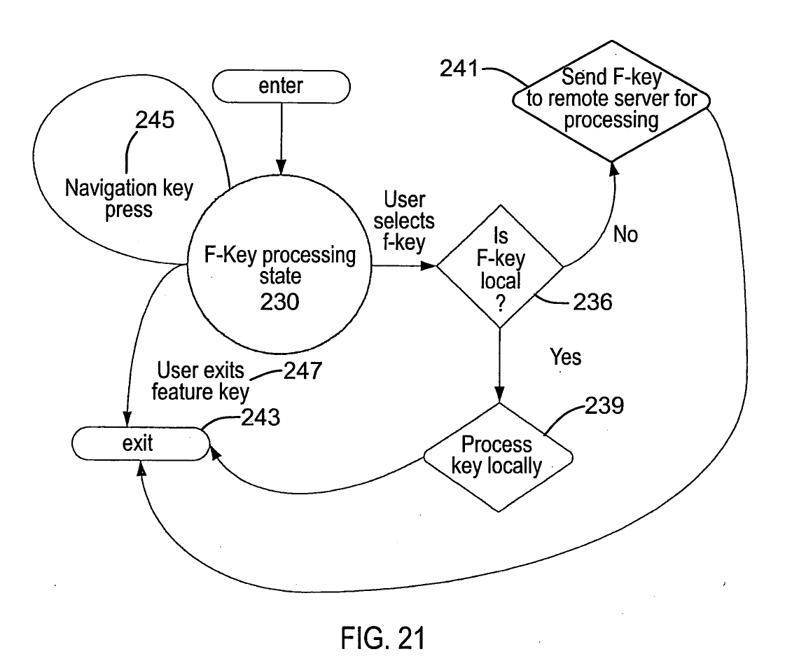

Referring to FIGS. 20 and 21, once a feature key 220 is pressed, it is converted to an event that indicates the key pressed as well as whether the key is to be processed locally or remotely. If the key is to be processed locally, local logic takes the event and processes it.

When a feature key 220 is to be displayed on a handset, for example, the handset 5 enters a feature key processing state 230. Key presses are recognized by key scan service 136 and the key is placed in an external event queue 232 from which a feature key engine 234 determines 236 if the key 220 is to be processed locally (on the handset 5) or remotely. If locally then the key is placed in an internal event queue 238 for processing 239 within the handset 5 (indicating generically as “rest of features” 240) and the feature key processing state is exited. If remotely then the key is transferred 241 over the radio module 67 to the base station 3 for processing and the handset 5 exits 243 the key processing state 230. If a navigation key on the handset is pressed 245 then it is typically ignored and the handset 5 returns to the feature key processing state 230. If an exit key is pressed 247 then the handset 5 exits 243 the feature key processing state 230.

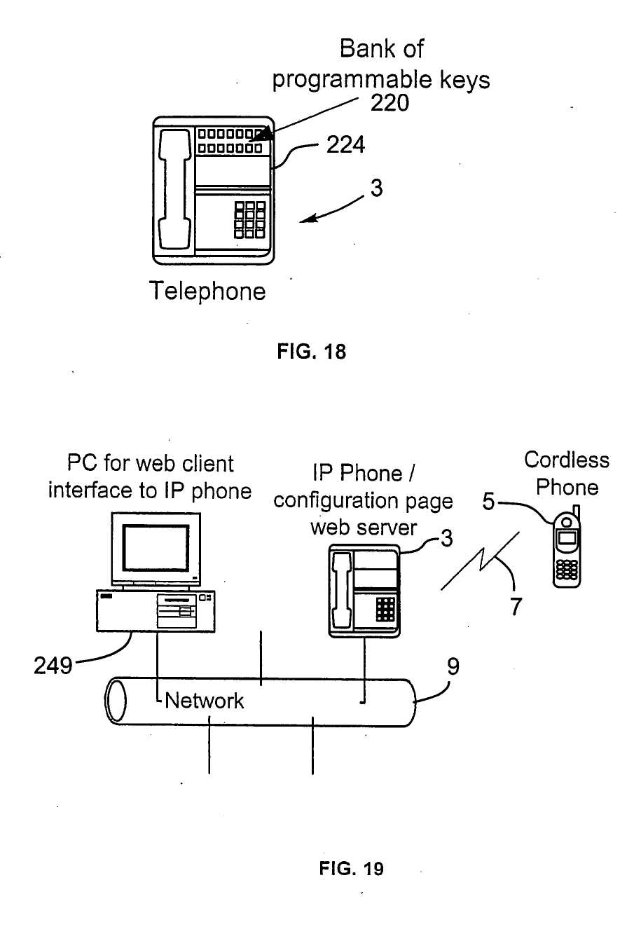

Referring to FIG. 19, the system 1 supports remote configuration from a network client such as a personal computer (PC) 249 connected to the base station 3 through a network 9.

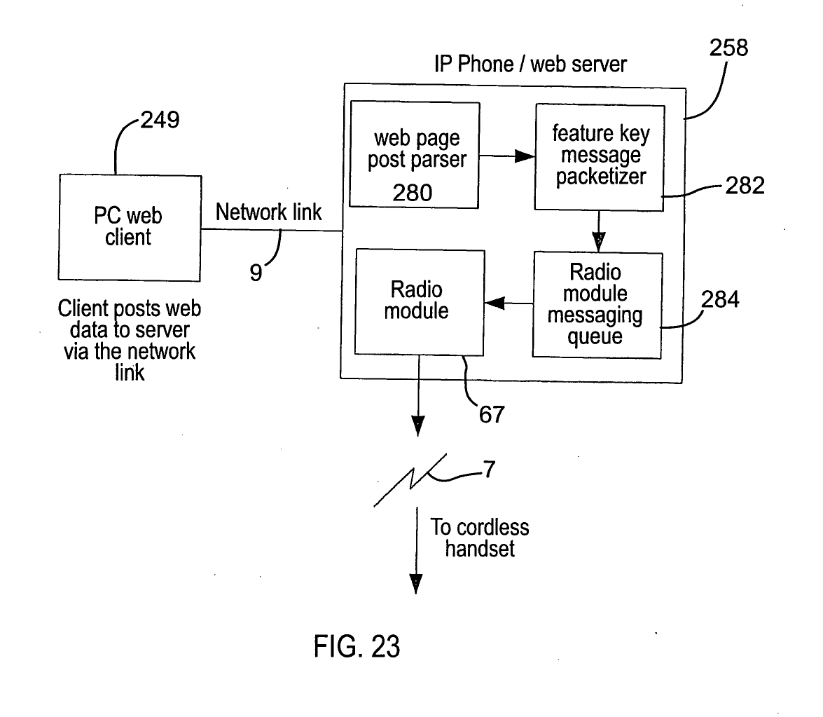

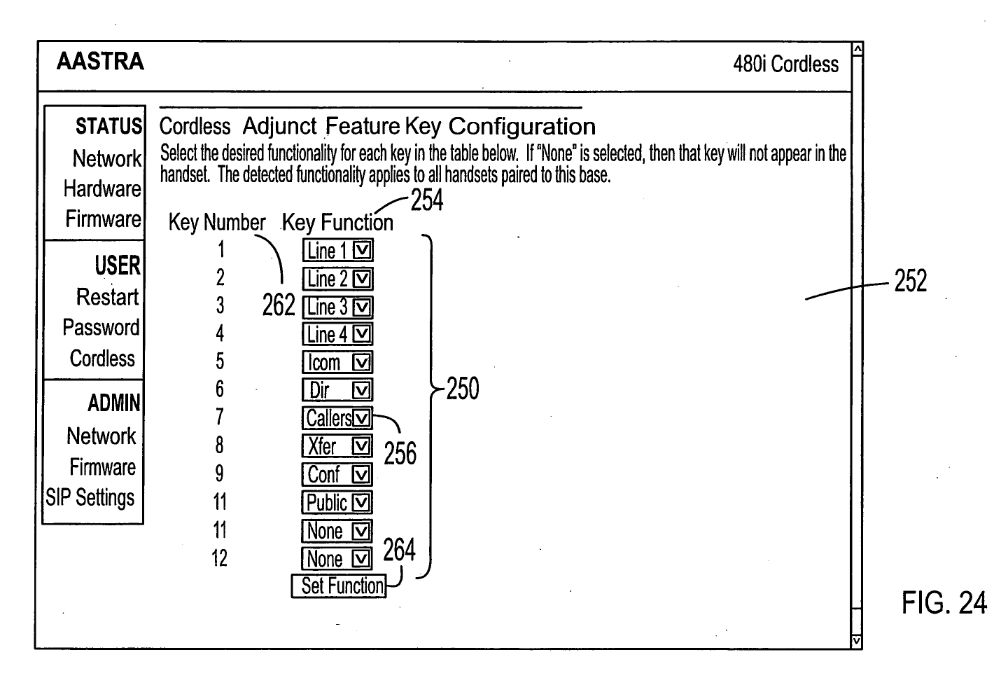

Referring to FIGS. 19 and 24, for example, handset feature keys in a feature key list 250 can be configured from a web page 252 that is served up from the base station 3. The configuration is function based. That is to say, the user selects the function 254 to be programmed to a key 220 from a drop down list (for example 256) on the web page and software determines whether the key is local or remote based on the function 254. The software for determining whether the key is local or remote is in the cordless handset 5. The web page 252 is served to the remote client 249, for example a personal computer running a supported web browser. The base station 3 has a built-in web server 258 (FIG. 23).

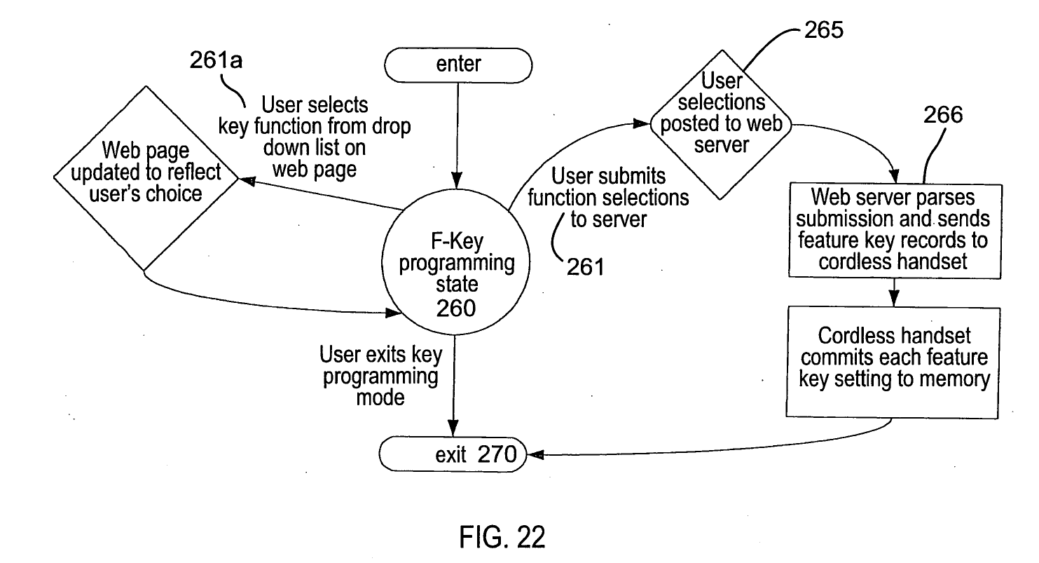

Referring to FIGS. 22 and 24, when the base station 3 receives a web post the base station 3 enters a feature key programming state 260. The user submits 261 function selections to the server 258, for example by selecting 261a a key function 254 for a key number 262 and clicking Set Function 264 on the web page 252. The user submission is posted 265 from the web page 252 to the web server 258. The web server parses 266 the submission and sends feature key records to the cordless handset 5. The cordless handset 5 stores 268 each feature key setting in memory 57 and exits 270 the feature key programming state 260.

In the preferred embodiment the selected functionality for a feature key is the same for all cordless handsets 5 for the base station 3. Those skilled in the art will recognize that it is possible to separately identify handsets 5 and program feature keys differently for different handsets 5. Of course, this results in a corresponding increase in complexity in coupling the handsets 5 and base station 3.

Referring to FIG. 23, for receiving function selections from a user the web server 258 has a web page post parser 280 for parsing web posts received from the web client 249. A feature key message packetizer 282 packages feature key messages and sends them to a radio module messaging queue 284 for transmission by the radio module 67 over the cordless link 7 to the cordless handset 5, not shown in FIG. 23. The base station 3 is responsible for transmitting the feature key function records to the handsets 5. It will be recognized by those skilled in the art that the web server also has other components, not shown, for updating the web page for the user.

Each handset 5 is registered to one base station 3 to allow multiple base stations 3 to be used in a given area without conflict. Both the base station 3 and handsets 5 support multiple registered handsets 5 for a single base station 3. Many methods of handset registration exist. Those skilled in the art will be able easily to create or to implement a registration method.

The system 1 can include an intercom feature where that feature is provided in the radio module. For example a cordless voice module (CVM) provided by National Semiconductor Corporation in conjunction with RTX Telecom provides this feature. This allows the base station 3 to call a handset 5, a handset 5 to call the base station 3, or a handset 5 to call another handset 5. Additional software is needed in the base station 3 and handset 5 to support the feature provide by the CVM. For example, a user interface similar to that in existing cordless phone products, such as an Aastra Telecom CB-16/3012 interface, can be used.

Barge-in protection or call privacy is a typical concern on systems that share CO (central office) lines. In the residential environment, multiple phones can be connected to a single line and any of those phones can go off hook to connect to the call. It used to be, and still is in some environments, that another user may be able to quietly remove the receiver of an extension phone to eavesdrop on the call. Many phones today have extension detection circuits and will display a warning to the user that an extension is active. An alternative solution in a system of phones such as the Nortel Venture (original) is to prevent its user from going off hook without first pressing a confirmation key to signal the intrusion is intentional.

In business systems, access to the lines is controlled by the KSU (key system unit or key services unit) and often there is no way to join a call other than through an invitation using the system's conference feature.

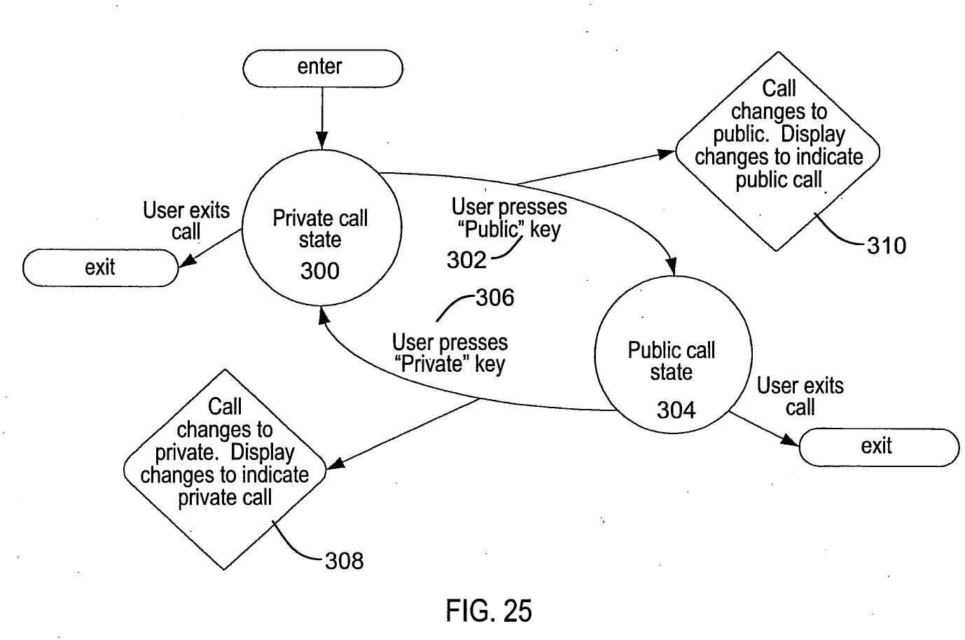

Referring to FIG. 25, as multiple handsets 5 can be connected to a base station 3, calls in the system 1 are designated as public or private. All calls are private by default, which means that other users (base station 3 or other handsets 5 registered to the same base station 3) cannot join the current call. The user that initiated the call can make the call public so others can join. Any member on the call can then make the call private again. Once in the call, a user is not ejected if the call changes from public to private but new users are not allowed to join at that point.

When a call commences then the call will enter a Private Call state 300. Preferably, the display of each device (base station 3 and handsets 5) on the call displays 308 an indicator of the Private Call state, for example the word “Private”. A Public key, for example a soft key such as those described previously, is provided on the display of the device that initiated the call. If the Public key is pressed 302 then the call enters a Public Call state 304. Similar to the Private Call state 300, the display of each device on the call displays 310 an indicator of the Public Call state, for example the word “Public”. A Private key, for example a soft key such as those described previously, is provided on the display of each device on the call. If the Private key is pressed 306 then the call enters the Private Call state 300. When a device exits a call, for example a user hangs-up, then it is removed from the call and the Private/Public Call state. The Private/Public call state is tracked and changed in the relevant line object of the base station line processing engine 81.

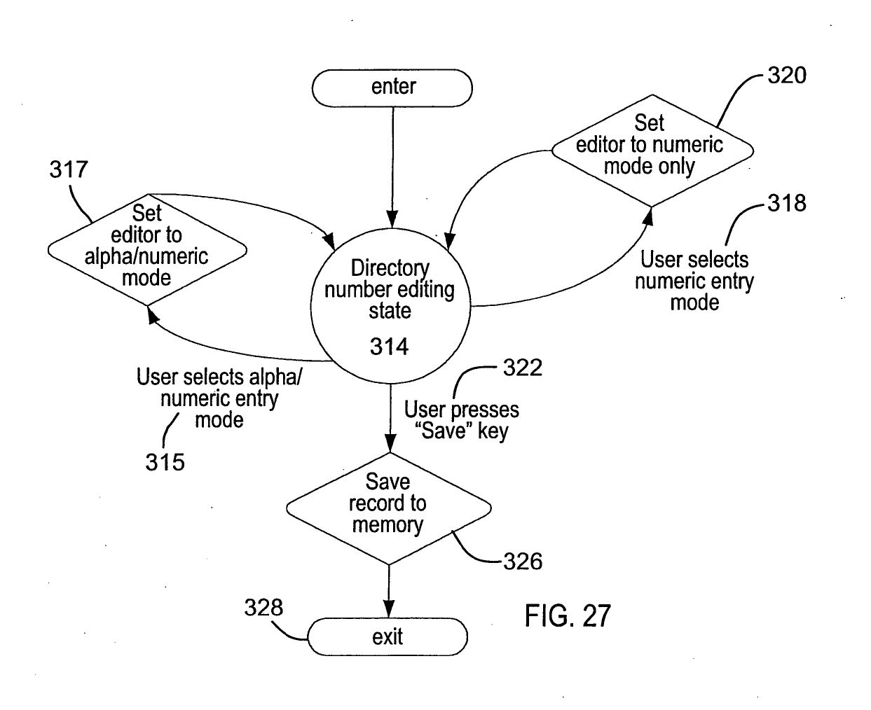

Referring to FIG. 27, the system 1 utilizes directory records 113 on the base station 3 and handsets 5 that accept alphanumeric characters for end point identifiers. An example directory record 113 display is shown in FIG. 10. The record includes a name entry 310 and an end point identifier entry, referred to as “Number” 312 in FIG. 10 in accordance with commonly understood telephone jargon for a user friendly interface. The base station 3 and each handset 5 has an editor with the state-flow diagram shown. When a directory record 113 is being viewed the respective base station 3 or handset 5 enters a directory number editing state 314. Soft keys for the selection of alphanumeric entry mode (the key 316 labelled “abc>” in FIG. 10) or numeric entry mode (if alphanumeric entry mode is selected 315 then the key 316 will toggle to “123” to permit the selection of numeric mode) can be provided on the respective base station 3 or handset 5. If alphanumeric mode is chosen then the editor is set 317 to alphanumeric entry and returns to directory number editing state 314. If numeric mode is chosen 318 then the editor is set 320 to numeric entry and returns to directory number editing state 314. In the directory number editing state 314, the directory record 113 can be edited simply by overwriting the entries in the name field and number field. If a user elects to save the record, for example by selecting 322 a feature key labelled save 120, then the record is saved 326 to memory, and the directory number editing state 314 is exited 328.

Alphanumeric characters include letters, digits and special characters such as punctuation. At a minimum for the current application special characters in the alphanumeric characters include the @ and . (period) symbols. Other special characters may include, for example, : (colon) and / (forward slash).

This provides a telephony base station 3 with the ability to enter end point identifiers using non-telephone numbers. E.164 has been adopted by the Internet telephony community to enter numbers to connect to any phone connected to the PSTN worldwide and to connect to IP phones connected to the Internet. However, there are other ways to reach end points on the Internet. SIP, for example, allows email like addresses to be used to reach an end point. An example of an endpoint identifier reachable by SIP is a SIP address in the format: sip://employee_name@company.com. The base station 3 and handsets 5 provide the ability to enter SIP addresses like the above into the number field of the phone book entry on the telephone in addition to standard E.164 numbers format. Back-end processing could be included to insert “sip://” when a sip address is used so that entry and use of the “://” characters is not required; however, these special characters could be provided in any to allow users to enter the full SIP address.

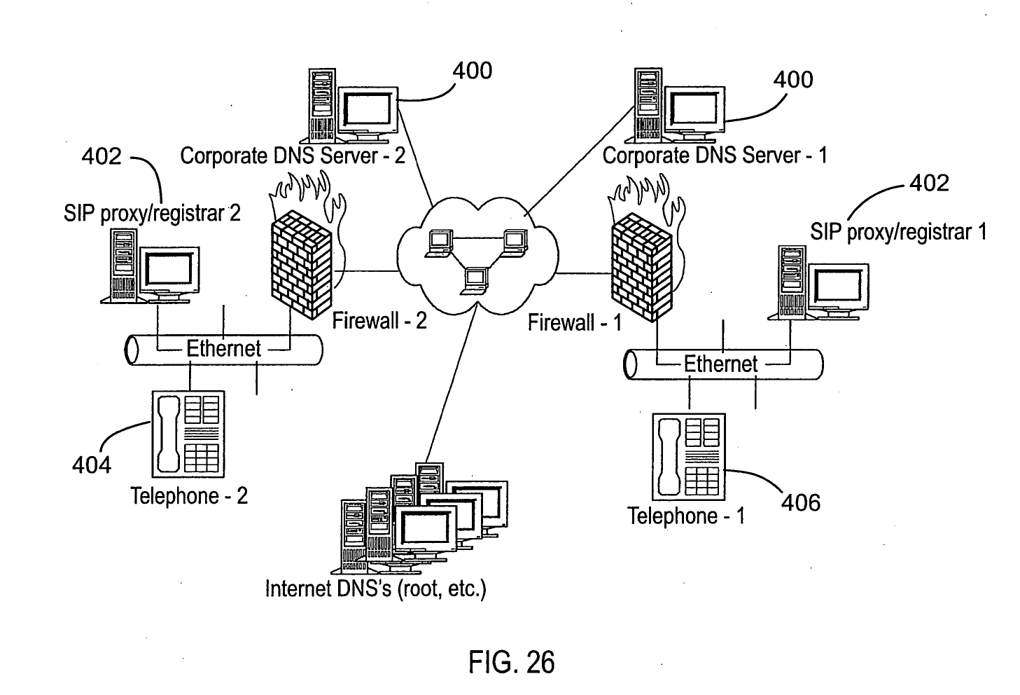

Referring to FIG. 26, using DNS servers 400 and SIP proxy servers 402 on the Internet, the above address would resolve down to an IP address and port sufficient to reach the target end point, for example IP telephone 2 404 from IP telephone 1 406. As the base station 3 can receive and store SIP URIs (uniform resource identifiers) it can call an IP telephone of a caller using the SIP URI. The URI is resolved using the Internet DNS's and then a corporate DNS server of the party being called. Finally, a SIP proxy/registrar provides final addressing to locate the phone. Once the location is known, a media path is opened in the firewalls and may proceed directly between the phones or between the SIP proxies depending on the specific set-up in each network.

This resolution process is transparent to the user that entered the SIP address and is handled by a SIP engine in the base station 3, not shown, at a low level in the call processing, as well as by network elements, many of which do not belong to the caller or callee, as discussed above.

The alphanumeric endpoint identifiers can be implemented for directory records on a telephony base station 3 with or without the cordless handset 5 features described herein.

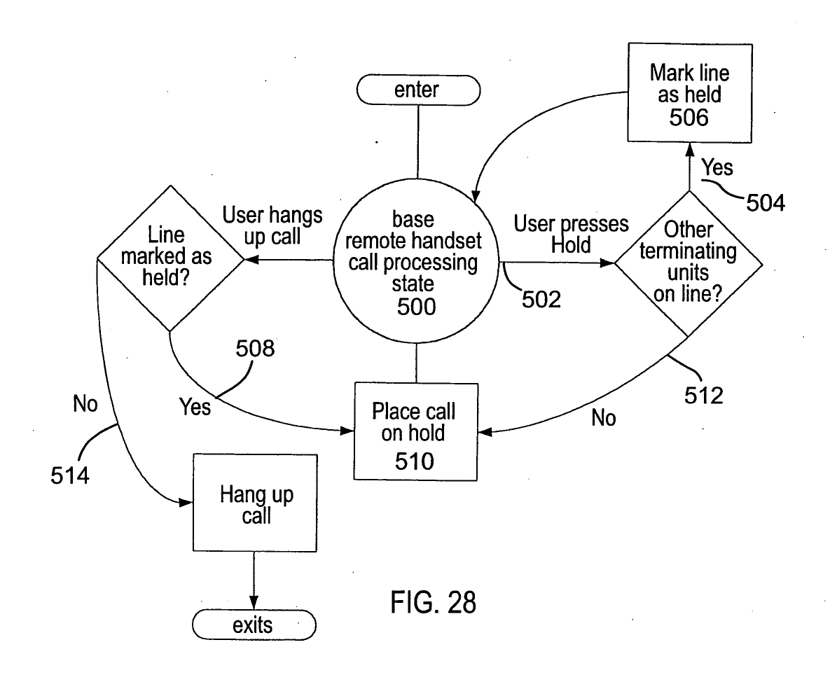

Referring to FIG. 28, when a handset 5 is in a call processing state 500 and requests 502 to hold a line that already has 504 at least one other handset 5 not on hold involved in the call the handset 5 will ‘mark for hold’ 506 the line in question rather than just aborting the call, as is the case with standard digital systems under similar circumstances. If a line has been marked for hold then the system 1 will only unmark the line by having the initiating handset 5 re-seize the line. If a line is hung up by all remaining extension devices when a line is marked for hold 508 it will cause the line to be placed into a hold state 510. If there are no other handsets 5 involved in the call when a handset 5 makes a hold request 512 then the call will be placed on hold 510. If a handset 5 hangs up and no other handsets 5 are on the line unheld and the line is not marked as held 514 then the cordless extension processing engine 73 hangs up the cordless call 516 and exits the call processing state.

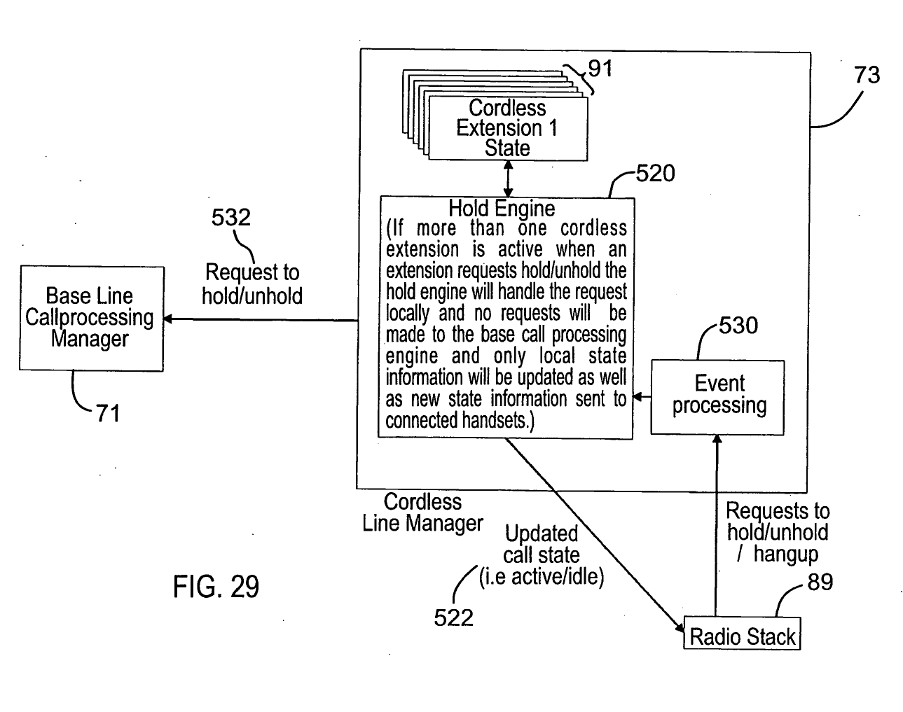

Referring to FIG. 29, to implement the above, the cordless extension engine 73 includes a hold engine 520 to simulate analog telephone hold behaviour. If more than one handset 5 is active when a handset 5 requests hold/unhold then the hold engine 520 will handle the request locally (within the hold engine 520). No request will be made to the base line processing engine 71. Local (cordless extension) state information 91 is updated as well as new (active/idle) state information is sent 522 to connected handsets 5 so that the state of the handset 5 can be updated (for example in an idle state the handset 5 can display that it is on hold (idle) and provide an unhold soft key and unhold (make active or the like) label on the handset. If a handset 5 makes an unhold request it is eventually received at the base station radio stack 89 and provided to the cordless extension engine 73 event processing module 530 for processing by the hold engine 520. If only one handset 5 is active when that handset 5 makes a hold request then the hold request is sent 532 to the base station line processing engine 71.

It will be understood by those skilled in the art that this description is made with reference to the preferred embodiment and that it is possible to make other embodiments employing the principles of the invention which fall within its spirit and scope as defined by the following claims.

We claim:

1. A telephony system comprising:
a) a base station including a base station radio transceiver for transmitting and receiving cordless telephone radio signals, and a network connection for transmitting and receiving voice over internet protocol (VoIP) communications, and
b) at least one handset, each handset including a handset radio transceiver for transmitting and receiving cordless telephone radio signals,
wherein the base station is for converting received VoIP communications to cordless telephone radio signals and transmitting converted cordless telephone radio signals through the base station radio transceiver,
wherein the base station is for converting cordless telephone radio signals received through the base station radio transceiver to VoIP communications and transmitting converted VoIP communications through the network connection,
wherein each handset is for receiving cordless telephone radio signals from the base station through the handset's radio transceiver and for transmitting cordless telephone radio signals through the handset's radio transceiver to the base station.

2. The system of claim 1 wherein the base station further comprises a VoIP processor and control unit for encoding and decoding VoIP communications using at least one selected codec.

3. The system of claim 2 wherein the base station further comprises at least one human interface device (HID) and the VoIP processor and control unit is also for controlling the least one base station HID.

4. The system of claim 3 wherein the at least one base station HID comprises a keypad and handset.

5. The system of claim 4 wherein the at least one HID further comprises a microphone and speaker.

6. The system of claim 4 wherein the at least one HID further comprises a display.

7. The system of claim 6 wherein the display is an LCD screen.

8. The system of claim 2 wherein the base station further comprises non-volatile memory and the VoIP processor and control unit further controls the non-volatile memory.

9. The system of claim 2 wherein the base station further comprises volatile memory and the VoIP processor and control unit further controls the volatile memory.

10. The system of claim 2 wherein the base station further comprises a base band processor connected between the VoIP processor and control unit and the base station radio transceiver, and wherein the VoIP processor and control unit transmits voice data decoded from received VoIP communications to the base band processor for encoding in accordance with cordless telephone protocols to produce cordless telephone radio signals for transmission through the base station radio transceiver.

11. The system of claim 10 wherein the base band processor is also for transmitting voice data decoded from cordless telephone radio signals received through the base station radio transceiver to the VoIP processor and control unit for encoding in accordance with VoIP.

12. The system of claim 1 wherein the base band radio transceiver is connected to a receive/transmit switch that is connected through a band pass filter to an antenna.

13. The system of claim 1 wherein the network connection is an Ethernet connection

14. The system of claim 10 wherein each handset further comprises a handset microprocessor, a handset base band processor and at least one handset HID, wherein the base band processor is connected to the handset radio transceiver and decodes voice data from received cordless telephone radio signal and encodes audio in accordance with a cordless telephone radio protocol, and the base band processor is connected to the handset microprocessor for transmitting control signals to the handset microprocessor and receiving control signals from the handset microprocessor, and voice data decoded by the base band processor are converted to sound through at least one HID and voice data converted from sound by at least one HID are encoded by the handset base band processor.

15. The system of claim 1 wherein the network communications are G.711 or G.723.1 encoded and the cordless telephone radio signals are G.729 encoded.

16. The system of claim 1 wherein the base station further comprises a base station line-processing engine that handles call progress and monitoring.

17. The system of claim 16 wherein the base station line processing engine comprises line objects responsible for managing aspects of a call including start up, steady state, hold, conference, and tear down.

18. The system of claim 1 wherein the base station further comprises an event processor that handles events generated by the system.

19. The system of claim 17 wherein the base station further comprises a cordless extension engine that handles binding one or more handsets to one or more base station line objects.

20. The system of claim 1 wherein the base station further comprises a media engine responsible for handling voice data.

21. The system of claim 1 wherein the media engine comprises at least one codec.

22. The system of claim 1 wherein the media engine comprises a plurality of codecs, at least one digital to analog converters (DACs), and at least one analog to digital converters (ADCs).

23. The system of claim 22 wherein the media engine further comprises at least one conference engine and one or more echo cancellers.

24. The system of claim 22 wherein the media engine further comprises a handsfree block.

25. The system of claim 22 wherein the media engine comprises two available streams, one is for base station calls and one for handset calls.

26. The system of claim 25 wherein both available streams may be used by a handset or the base station for conference calling.

27. The system of claim 22 wherein the media engine comprises one available stream for the base station and each handset, such that the base station and each handset may have its own separate call.

28. The system of claim 22 wherein the media engine comprises two available streams for the base station and each handset, such that the base station and each handset may have its own conference call.

29. The system of claim 1 wherein the base station and handsets each comprise directory records that can be used to make calls.

30. The system of claim 29 wherein the directory records may be public or private, and each public record is broadcast from the base station to the handsets, and the handsets add records to a handset directory record database when the handset is within range of the base station and the record is broadcast.

31. The system of claim 30 wherein when a public record is displayed an icon indicates that the record is public.

32. The system of claim 31 wherein the icon is a large (as compared to other text on the display) bold “P” to indicate the record is public.

33. The system of claim 1 wherein the base station further comprises navigation keys on the base station, and wherein the navigation keys are utilized as shortcut keys to phone features during a base station idle state.

34. The system of claim 1 wherein the base station further comprises a “SORT” soft key, and the base station sorts call log records alphabetically when the SORT soft key is pressed.

35. The system of claim 1 wherein the base station enables searching of call log records by entering the name of the caller as it might appear in the call log records.

36. The system of claim 1 wherein the base station comprises a full set of supported codecs for VoIP, and a reduced set of supported codecs for use to maintain available resources for service of concurrent calls.

37. The system of claim 1 wherein the base station supports remote configuration from a network client connected to the base station through the network connection.

38. The system of claim 37 wherein feature keys in the system may be remotely configured through a web page served up from the base station.

39. The system of claim 1 wherein calls in the system can be marked public or private, and the base station does not permit handsets to join a call that is marked private.

40. The system of clam 29 wherein the directory records accept alphanumeric characters for VoIP communication end point identifiers, such alphanumeric characters comprising letters, digits and special characters.

41. The system of claim 40 where special characters comprise @ and . (period) symbols.

42. The system of claim 1 wherein the base station further comprises a hold engine to simulate analog telephone hold behaviour.

43. The system of claim 42 wherein the hold engine is for marking a line as held if more than one cordless extension is on the call when an extension requests to be held and updating the state of that extension.

44. A telephony base station comprising:
a) a network connection for transmitting and receiving voice over internet protocol (VoIP) communications, and
b) at least one human interface device (HID),
wherein the base station is for processing sound received through the at least one human interface device and converting the sound to VoIP communications for transmission through the network connection and for processing VoIP communications received through the network connection and converting the VoIP communications to voice data for transmission through the at least one human interface device,
wherein the base station further comprises navigation keys on the base station,
and wherein the navigation keys are utilized as shortcut keys to base station features.

45. A telephony base station comprising:
a) a network connection for transmitting and receiving voice over internet protocol (VoIP) communications, and
b) at least one human interface device (HID),
wherein the base station is for processing sound received through the at least one human interface device and converting the sound to VoIP communications for transmission through the network connection, and for processing VoIP communications received through the network connection and converting the VoIP communications to voice data for transmission through the at least one human interface device, and
wherein the base station further comprises a “SORT” soft key, and the base station sorts call log records alphabetically when the SORT soft key is pressed.

46. A telephony base station comprising:
a) a network connection for transmitting and receiving voice over internet protocol (VoIP) communications, and
b) at least one human interface device (HID),
wherein the base station is for processing sound received through the at least one human interface device and converting the sound to VoIP communications for transmission through the network connection, and for processing VoIP communications received through the network connection and converting the VoIP communications to voice data for transmission through the at least one human interface device, and
wherein the base station enables searching of call log records by entering the name of the caller as it might appear in the call log records.

47. A telephony base station comprising:
a) a network connection for transmitting and receiving voice over internet protocol (VoIP) communications, and
b) at least one human interface device (HID),
wherein the base station is for processing sound received through the at least one human interface device and converting the sound to VoIP communications for transmission through the network connection, and for processing VoIP communications received through the network connection and converting the VoIP communications to voice data for transmission through the at least one human interface device,
wherein the base station and handsets each comprise directory records that can be used to make calls, and
wherein the directory records accept alphanumeric characters for VoIP communication end point identifiers, such alphanumeric characters comprising letters, digits and special characters.

48. The system of claim 47 where special characters comprise @ and . (period) symbols.
